(19) United States
(12) Patent Application Publication
(10) Pub. No.: US 2025/0350405 A1
(43) Pub. Date: Nov. 13, 2025

(54) METHOD AND DEVICE FOR HARQ IN NON-TERRESTRIAL NETWORK

(71) Applicants: Hyundai Motor Company, Seoul (KR); Kia Corporation, Seoul (KR)

(72) Inventors: Young Kil Suh, Hwaseong, Gyeonggi-do (KR); Gene Back Hahn, Hwaseong, Gyeonggi-do (KR); Ui Hyun Hong, Hwaseong, Gyeonggi-do (KR)

(21) Appl. No.: 18/862,278

(22) PCT Filed: May 3, 2023
(86) PCT No.: PCT/KR2023/006072

§ 371 Date: Nov. 1, 2024

(30) Foreign Application Priority Data
May 4, 2022 (KR) 10-2022-0055366

(51) Int. Cl. H04L 1/1812; H04B 7/185; H04W 72/231; H04W 92/20

(52) U.S. Cl. CPC H04L 1/1812; H04B 7/18539; H04W 72/231; H04W 92/20

(57) ABSTRACT

A method of a first communication node, according to the present disclosure, may comprise the steps of: requesting resource allocation of a second non-terrestrial network (NTN) link between a second communication node and a user equipment (UE) in order to receive hybrid automatic repeat request (HARQ) feedback from the UE through the second communication node; transmitting, through a first NTN link passing through a first satellite, downlink control information (DCI) for the transmission of data to the UE on the basis of an acceptance response to resource allocation of the second NTN link to the UE from the second communication node; transmitting data to the UE through the first NTN link on the basis of the downlink control information; and receiving, from the UE, through the second communication node, an HARQ feedback signal corresponding to the transmitted data.

### TECHNICAL FIELD

The present disclosure relates to a hybrid automatic repeat request (HARQ) technique in a non-terrestrial network (NTN), and more particularly, to an HARQ technique in an NTN.

### BACKGROUND ART

A communication network (e.g. 5G communication network, 6G communication network, etc.) to provide enhanced communication services compared to the existing communication network (e.g. long term evolution (LTE), LTE-Advanced (LTA-A), etc.) is being developed. The 5G communication network (e.g. new radio (NR) communication network) can support not only a frequency band of 6 GHz or below, but also a frequency band of 6 GHz or above. That is, the 5G communication network can support a frequency range (FR1) band and/or FR2 band. The 5G communication network can support various communication services and scenarios compared to the LTE communication network. For example, usage scenarios of the 5G communication network may include enhanced Mobile BroadBand (eMBB), Ultra Reliable Low Latency Communication (URLLC), Massive Machine Type Communication (mMTC), and the like.

The 6G communication network can support a variety of communication services and scenarios compared to the 5G communication network. The 6G communication networks can meet the requirements of hyper-performance, hyper-bandwidth, hyper-space, hyper-precision, hyper-intelligence, and/or hyper-reliability. The 6G communication networks can support various and wide frequency bands and can be applied to various usage scenarios (e.g. terrestrial communication, non-terrestrial communication, sidelink communication, and the like).

The communication network (e.g. 5G communication network, 6G communication network, etc.) may provide communication services to terminals located on the ground. Recently, the demand for communication services for not only terrestrial but also non-terrestrial airplanes, drones, and satellites has been increasing, and for this purpose, technologies for a non-terrestrial network (NTN) have been discussed. The non-terrestrial network may be implemented based on 5G communication technology, 6G communication technology, and/or the like. For example, in the non-terrestrial network, communication between a satellite and a terrestrial communication node or a non-terrestrial communication node (e.g. airplane, drone, or the like) may be performed based on 5G communication technology, 6G communication technology, and/or the like. In the NTN, the satellite may perform functions of a base station in a communication network (e.g. 5G communication network, 6G communication network, and/or the like).

Meanwhile, in a multi-link environment composed solely of existing terrestrial networks (TNs), a propagation delay in a wireless channel of each link is less than 0.1 milliseconds. In contrast, in a multi-link environment including NTN, a propagation delay in a wireless channel of each link ranges from several milliseconds to several hundred milliseconds. This means that in the multi-link environment including NTN, there may be significant differences in propagation delays among links.

It is expected that the disadvantages of links with large delays in the multi-link environment including NTN can be overcome by actively utilizing a link with small delays. However, specific methods for utilizing a link with small delays to overcome the disadvantages of links with large delays in the multi-link environment including NTN have not yet been proposed.

### DISCLOSURE

### Technical Problem

The present disclosure is directed to providing a signaling method and device for transmitting an HARQ feedback for a transport block (TB) transmitted through a link having a large latency and retransmission data for the TB through a link having a small latency in a non-terrestrial network (NTN).

The present disclosure is also directed to a method and a device for resolving a problem of a timing for an HARQ feedback for a TB transmitted through a link having a large latency and retransmission for the TB.

### Technical Solution

A method of a first communication node, according to the present disclosure for achieving the above-described objective, may comprise: requesting allocation of a resource on a second non-terrestrial network (NTN) link between a second communication node and a user equipment (UE) to receive a hybrid automatic repeat request (HARQ) feedback from the UE via the second communication node; in response to a response of acceptance to the allocation of the resource on the second NTN link from the second communication node, transmitting, through a first NTN link via a first satellite, downlink control information (DCI) for transmitting data to the UE; transmitting the data to the UE through the first NTN link based on the DCI; and receiving an HARQ feedback signal corresponding to the transmitted data from the UE via the second communication node.

The second NTN link may be a link with a shorter latency than the first NTN link.

The downlink control information may include an indicator indicating to transmit the HARQ feedback signal through the second NTN link and allocation information of at least one of a physical uplink control channel (PUCCH) or physical uplink shared channel (PUSCH) on the second NTN link to transmit the HARQ feedback signal.

The allocation information of the PUCCH on the second NTN link may include information on a transmission timing, time resource-related information, and frequency resource-related information for the PUCCH on the second NTN link.

The HARQ feedback signal corresponding to the transmitted data, which is received from the second communication node, may be received through a backhaul using an Xn interface between the second communication node and the first communication node.

The second NTN link may be a link established for communication between the second communication node and the UE via a second satellite.

The method may further comprise: in response to that the HARQ feedback signal received from the UE indicates a data decoding failure, determining an NTN link to retransmit the transmitted data; in response to that the determined NTN link is the second NTN link, transmitting, to the second communication node, a retransmission request including retransmission data and an HARQ process number; and receiving, from the second communication node, information on whether or not the retransmission data is successfully received at the UE.

In the determining of the link to retransmit the transmitted data, the link may be determined based on at least one of a Quality of Service (QoS) required by the transmitted data, characteristics of the transmitted data, or a congestion level of the second communication node.

A method of a first communication node, according to the present disclosure for achieving the above-described objective, may comprise: receiving, from a second communication node, a request for allocation of a resource on a first non-terrestrial network (NTN) link to receive a hybrid automatic repeat request (HARQ) feedback for data transmitted through a second NTN link established between the second communication node and a user equipment (UE); in response to the request for allocation, allocating a resource on the first NTN link for receiving a first HARQ feedback signal from the UE for data transmitted through the second NTN link; in response to allocating the resource, transmitting an acceptance response signal including information on the resource allocated on the first NTN link to the second communication node; in response to the information on the resource allocated on the first NTN link, receiving the first HARQ feedback signal from the UE for the data transmitted through the second NTN link; and delivering the received first HARQ feedback signal to the second communication node.

The first NTN link may be a link with a shorter latency than the second NTN link.

The resource allocated on the first NTN link may be at least one of a physical uplink control channel (PUCCH) resource or physical uplink shared channel (PUSCH) resource.

In the allocating of the resource on the first NTN link for receiving the first HARQ feedback signal for data transmitted through the second NTN link, whether to allocate the resource on the first NTN link may be determined based on at least one of whether a resource allocatable as a PUCCH resource exists, a congestion level of the first NTN link, or a load state of the first communication node.

The allocation information of the PUCCH on the first NTN link may include information on a transmission timing, time resource-related information, and frequency resource-related information for the PUCCH on the first NTN link.

The first HARQ feedback, which is received from the second communication node, may be received through a backhaul using an Xn interface with the second communication node.

The method may further comprise: receiving, from the second communication node, a retransmission request for the data transmitted through the second NTN link; transmitting retransmission data to the UE through the first NTN link based on the retransmission request; and receiving, from the UE, a second HARQ feedback signal corresponding to the retransmission data.

The retransmission request may include the retransmission data and an HARQ process number.

The method may further comprise: delivering the received second HARQ feedback signal for the retransmission data to the second communication node.

A method of a user equipment (UE), according to the present disclosure for achieving the above-described objective, may comprise: receiving downlink control information (DCI) through a first non-terrestrial network (NTN) link via a first satellite; receiving data through the first NTN link based on the DCI; demodulating and decoding the data received through the first NTN link; generating a first hybrid automatic repeat request (HARQ) feedback signal based on a result of the decoding; and in response to the DCI indicating to transmit the first HARQ feedback signal through a second NTN link via a second satellite, transmitting the first HARQ feedback signal corresponding to the data received through the first NTN link to the second satellite of the second NTN link.

The DCI may include an indicator indicating to transmit the first HARQ feedback signal through the second NTN link, time resource-related information, and frequency resource-related information.

The second NTN link may be a link established for communication via the second satellite.

### Advantageous Effects

When applying the devices and methods according to the present disclosure, fast HARQ feedback is possible in non-terrestrial networks, thereby increasing a data retransmission speed. Furthermore, applying the devices and methods according to the present disclosure allows for appropriate adjustment of HARQ feedback timing and retransmission data timing.

### DESCRIPTION OF DRAWINGS

FIG. 1A is a conceptual diagram illustrating a first exemplary embodiment of a non-terrestrial network.

FIG. 1B is a conceptual diagram illustrating a second exemplary embodiment of a non-terrestrial network.

FIG. 2A is a conceptual diagram illustrating a third exemplary embodiment of a non-terrestrial network.

FIG. 2B is a conceptual diagram illustrating a fourth exemplary embodiment of a non-terrestrial network.

FIG. 2C is a conceptual diagram illustrating a fifth exemplary embodiment of a non-terrestrial network.

FIG. 3 is a block diagram illustrating a first exemplary embodiment of a communication node constituting a non-terrestrial network.

FIG. 4 is a block diagram illustrating a first exemplary embodiment of communication nodes performing communication.

FIG. 5A is a block diagram illustrating a first exemplary embodiment of a transmission path.

FIG. 5B is a block diagram illustrating a first exemplary embodiment of a reception path.

FIG. 6A is a conceptual diagram illustrating a first exemplary embodiment of a protocol stack of a user plane in a transparent payload-based non-terrestrial network.

FIG. 6B is a conceptual diagram illustrating a first exemplary embodiment of a protocol stack of a control plane in a transparent payload-based non-terrestrial network.

FIG. 7A is a conceptual diagram illustrating a first exemplary embodiment of a protocol stack of a user plane in a regenerative payload-based non-terrestrial network.

FIG. 7B is a conceptual diagram illustrating a first exemplary embodiment of a protocol stack of a control plane in a regenerative payload-based non-terrestrial network.

FIG. 8A is a conceptual diagram illustrating a configuration of a non-terrestrial network according to a first exemplary embodiment.

FIG. 8B is a conceptual diagram illustrating a configuration of a non-terrestrial network according to a second exemplary embodiment.

FIG. 9A is a conceptual diagram illustrating a case where one terminal is in a state of dual connectivity with two different TNs.

FIG. 9B is a conceptual diagram illustrating a case where one terminal is in a state of dual connectivity with an NTN comprising two different LEO satellites.

FIG. 9C is a conceptual diagram illustrating a case where one terminal is connected to two different LEO satellites operating as multiple TRPs.

FIG. 9D is a conceptual diagram illustrating a case where one terminal is connected to satellites at different altitudes.

FIG. 9E is a conceptual diagram illustrating a case where one terminal is connected to satellites at different altitudes operating as multiple TRPs.

FIG. 10A is a conceptual diagram illustrating configuration of an HARQ feedback link when one terminal is in a state of multi-connectivity with satellites at different altitudes according to a first exemplary embodiment of the present disclosure.

FIG. 10B is a conceptual diagram illustrating configuration of an HARQ feedback link when one terminal is connected to satellites at different altitudes operating as multiple TRPs according to a second exemplary embodiment of the present disclosure.

FIG. 11A is a signal flow diagram for a case of transmitting an HARQ feedback when one terminal is in a state of multi-connectivity via satellites at different altitudes according to a first exemplary embodiment of the present disclosure.

FIG. 11B is a signal flow diagram for another case of transmitting an HARQ feedback when one terminal is in a state of multi-connectivity via satellites at different altitudes according to the first exemplary embodiment of the present disclosure.

FIG. 12A is a signal flow diagram for a case of transmitting an HARQ feedback when one terminal is connected to satellites at different altitudes operating as multiple TRPs according to a second exemplary embodiment of the present disclosure.

FIG. 12B is a signal flow diagram for a case of transmitting an HARQ feedback when one terminal is connected to satellites at different altitudes operating as multiple TRPs according to the second exemplary embodiment of the present disclosure.

FIG. 13 is a timing diagram of an NTN link through which data is transmitted and a sub-link corresponding thereto in a multi-connectivity environment according to an exemplary embodiment of the present disclosure.

FIG. 14 is a signal flow diagram for data retransmission when one terminal is in a state of multi-connectivity via multiple satellites at different altitudes according to the present disclosure.

FIG. 15 is a timing diagram for respective links when one terminal retransmits data through a sub-link in a situation where one terminal is in a state of multi-connectivity with multiple links according to an exemplary embodiment of the present disclosure.

### MODE FOR INVENTION

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In the present disclosure, “at least one of A and B” may mean “at least one of A or B” or “at least one of combinations of one or more of A and B”. Also, in exemplary embodiments of the present disclosure, “one or more of A and B” may mean “one or more of A or B” or “one or more of combinations of one or more of A and B”.

In the present disclosure, “(re)transmission” may refer to “transmission”, “retransmission”, or “transmission and retransmission”, “(re)configuration” may refer to “configuration”, “reconfiguration”, or “configuration and reconfiguration”, “(re)connection” may refer to “connection”, “reconnection”, or “connection and reconnection”, and “(re)access” may mean “access”, “re-access”, or “access and re-access”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The terminology used herein is for the purpose of describing particular embodiments only and is not intended to be limiting of the present disclosure. As used herein, the singular forms are intended to include the plural forms as well, unless the context clearly indicates otherwise. It will be further understood that the terms “comprise” and/or “include” when used herein, specify the presence of stated features, integers, steps, operations, elements, components or combinations thereof, but do not preclude the presence or addition of one or more other features, integers, steps, operations, elements, components, and/or combinations thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted. In addition to the exemplary embodiments explicitly described in the present disclosure, operations may be performed according to a combination of the exemplary embodiments, extensions of the exemplary embodiments, and/or modifications of the exemplary embodiments. Performance of some operations may be omitted, and the order of performance of operations may be changed.

Even when a method (e.g. transmission or reception of a signal) performed at a first communication node among communication nodes is described, a corresponding second communication node may perform a method (e.g. reception or transmission of the signal) corresponding to the method performed at the first communication node. That is, when an operation of a user equipment (UE) is described, a base station corresponding to the UE may perform an operation corresponding to the operation of the UE. Conversely, when an operation of a base station is described, a UE corresponding to the base station may perform an operation corresponding to the operation of the base station. In a non-terrestrial network (NTN) (e.g. payload-based NTN), operations of a base station may refer to operations of a satellite, and operations of a satellite may refer to operations of a base station.

The base station may refer to a NodeB, evolved NodeB (eNodeB), next generation node B (gNodeB), gNB, device, apparatus, node, communication node, base transceiver station (BTS), radio remote head (RRH), transmission reception point (TRP), radio unit (RU), road side unit (RSU), radio transceiver, access point, access node, and/or the like. The UE may refer to a terminal, device, apparatus, node, communication node, end node, access terminal, mobile terminal, station, subscriber station, mobile station, portable subscriber station, on-broad unit (OBU), and/or the like.

In the present disclosure, signaling may be at least one of higher layer signaling, medium access control (MAC) signaling, or physical (PHY) signaling. Messages used for higher layer signaling may be referred to as ‘higher layer messages’ or ‘higher layer signaling messages’. Messages used for MAC signaling may be referred to as ‘MAC messages’ or ‘MAC signaling messages’. Messages used for PHY signaling may be referred to as ‘PHY messages’ or ‘PHY signaling messages’. The higher layer signaling may refer to a transmission and reception operation of system information (e.g. master information block (MIB), system information block (SIB)) and/or RRC messages. The MAC signaling may refer to a transmission and reception operation of a MAC control element (CE). The PHY signaling may refer to a transmission and reception operation of control information (e.g. downlink control information (DCI), uplink control information (UCI), and sidelink control information (SCI)).

In the present disclosure, “an operation (e.g. transmission operation) is configured” may mean that “configuration information (e.g. information element(s) or parameter(s)) for the operation and/or information indicating to perform the operation is signaled”. “Information element(s) (e.g. parameter(s)) are configured” may mean that “corresponding information element(s) are signaled”. In the present disclosure, “signal and/or channel” may mean a signal, a channel, or “signal and channel,” and “signal” may be used to mean “signal and/or channel”.

A communication system may include at least one of a terrestrial network, non-terrestrial network, 4G communication network (e.g. long-term evolution (LTE) communication network), 5G communication network (e.g. new radio (NR) communication network), or 6G communication network. Each of the 4G communications network, 5G communications network, and 6G communications network may include a terrestrial network and/or a non-terrestrial network. The non-terrestrial network may operate based on at least one communication technology among the LTE communication technology, 5G communication technology, or 6G communication technology. The non-terrestrial network may provide communication services in various frequency bands.

The communication network to which exemplary embodiments are applied is not limited to the content described below, and the exemplary embodiments may be applied to various communication networks (e.g. 4G communication network, 5G communication network, and/or 6G communication network). Here, a communication network may be used in the same sense as a communication system.

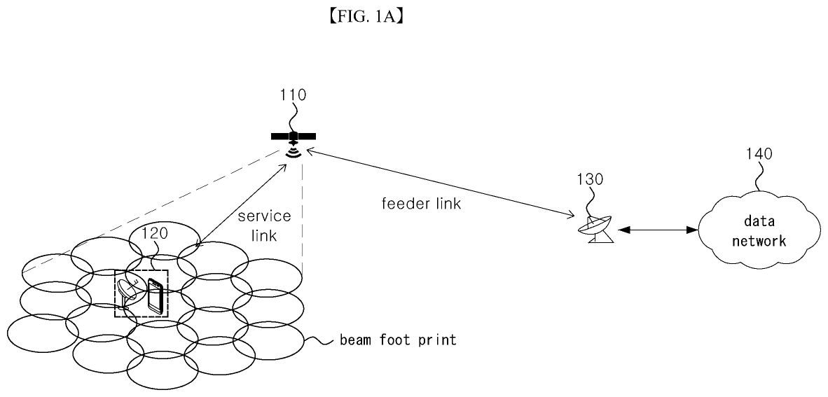

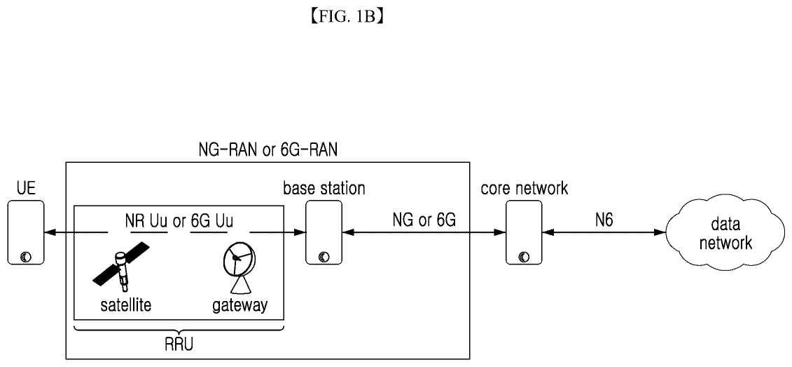

FIG. 1A is a conceptual diagram illustrating a first exemplary embodiment of a non-terrestrial network.

As shown in FIG. 1A, a non-terrestrial network (NTN) may include a satellite 110, a communication node 120, a gateway 130, a data network 140, and the like. A unit including the satellite 110 and the gateway 130 may correspond to a remote radio unit (RRU). The NTN shown in FIG. 1A may be an NTN based on a transparent payload. The satellite 110 may be a low earth orbit (LEO) satellite, a medium earth orbit (MEO) satellite, a geostationary earth orbit (GEO) satellite, a high elliptical orbit (HEO) satellite, or an unmanned aircraft system (UAS) platform. The UAS platform may include a high altitude platform station (HAPS). A non-GEO satellite may be an LEO satellite and/or MEO satellite.

The communication node 120 may include a communication node (e.g. a user equipment (UE) or a terminal) located on a terrestrial site and a communication node (e.g. an airplane, a drone) located on a non-terrestrial space. A service link may be established between the satellite 110 and the communication node 120, and the service link may be a radio link. The satellite 110 may provide communication services to the communication node 120 using one or more beams. The shape of a footprint of the beam of the satellite 110 may be elliptical or circular.

In the non-terrestrial network, three types of service links can be supported as follows.
Earth-fixed: a service link may be provided by beam(s) that continuously cover the same geographic area at all times (e.g. geosynchronous orbit (GSO) satellite).
quasi-earth-fixed: a service link may be provided by beam(s) covering one geographical area during a limited period and provided by beam(s) covering another geographical area during another period (e.g. non-GSO (NGSO) satellite forming steerable beams).
earth-moving: a service link may be provided by beam(s) moving over the Earth's surface (e.g. NGSO satellite forming fixed beams or non-steerable beams).

The communication node 120 may perform communications (e.g. downlink communication and uplink communication) with the satellite 110 using 4G communication technology, 5G communication technology, and/or 6G communication technology. The communications between the satellite 110 and the communication node 120 may be performed using an NR-Uu interface and/or 6G-Uu interface. When dual connectivity (DC) is supported, the communication node 120 may be connected to other base stations (e.g. base stations supporting 4G, 5G, and/or 6G functionality) as well as the satellite 110, and perform DC operations based on the techniques defined in 4G, 5G, and/or 6G technical specifications.

The gateway 130 may be located on a terrestrial site, and a feeder link may be established between the satellite 110 and the gateway 130. The feeder link may be a radio link. The gateway 130 may be referred to as a ‘non-terrestrial network (NTN) gateway’. The communications between the satellite 110 and the gateway 130 may be performed based on an NR-Uu interface, a 6G-Uu interface, or a satellite radio interface (SRI). The gateway 130 may be connected to the data network 140. There may be a ‘core network’ between the gateway 130 and the data network 140. In this case, the gateway 130 may be connected to the core network, and the core network may be connected to the data network 140. The core network may support the 4G communication technology, 5G communication technology, and/or 6G communication technology. For example, the core network may include an access and mobility management function (AMF), a user plane function (UPF), a session management function (SMF), and the like. The communications between the gateway 130 and the core network may be performed based on an NG-C/U interface or 6G-C/U interface.

As shown in an exemplary embodiment of FIG. 1B, there may be a ‘core network’ between the gateway 130 and the data network 140 in a transparent payload-based NTN.

FIG. 1B is a conceptual diagram illustrating a second exemplary embodiment of a non-terrestrial network.

As shown in FIG. 1B, the gateway may be connected with the base station, the base station may be connected with the core network, and the core network may be connected with the data network. Each of the base station and core network may support the 4G communication technology, 5G communication technology, and/or 6G communication technology. The communications between the gateway and the base station may be performed based on an NR-Uu interface or 6G-Uu interface, and the communications between the base station and the core network (e.g. AMF, UPF, SMF, and the like) may be performed based on an NG-C/U interface or 6G-C/U interface.

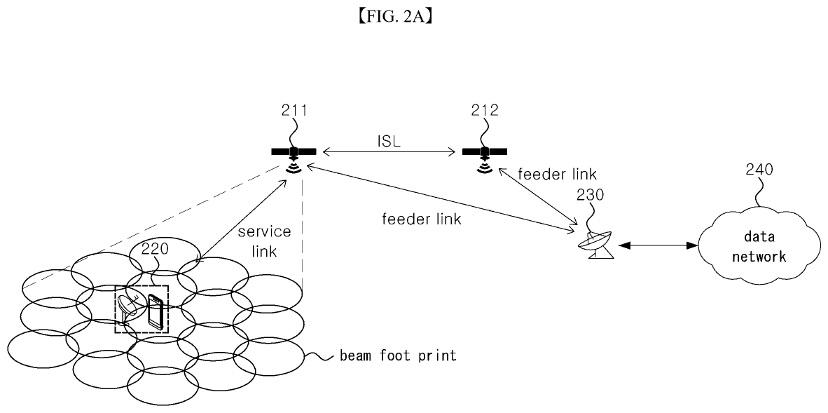

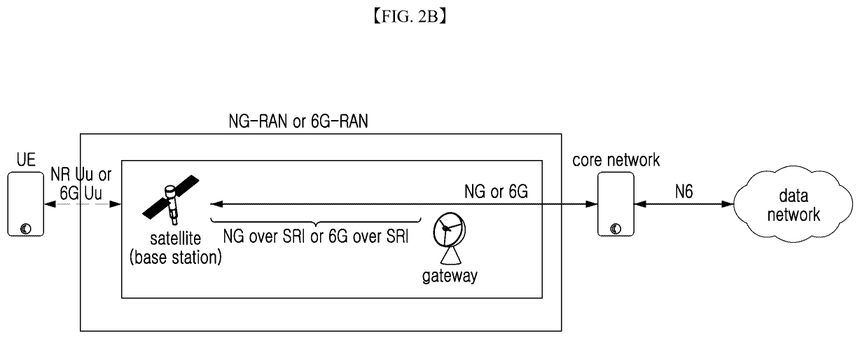

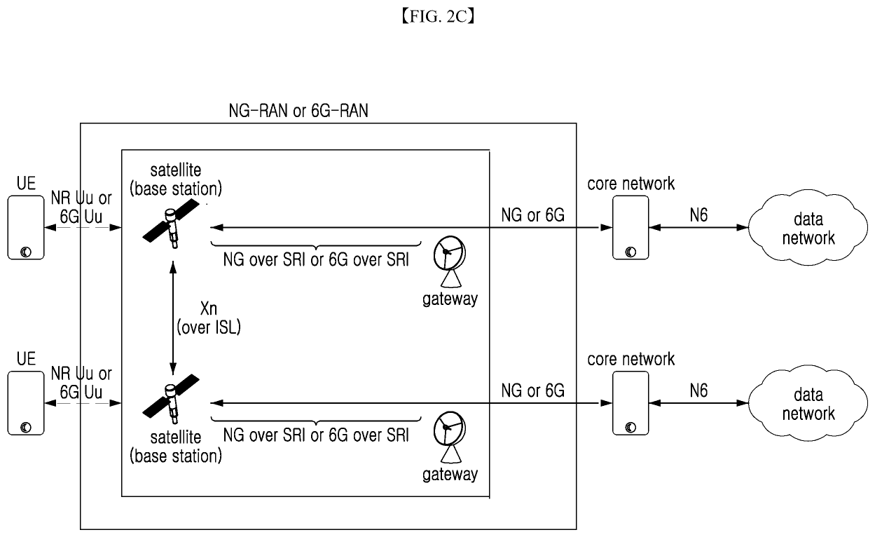

FIG. 2A is a conceptual diagram illustrating a third exemplary embodiment of a non-terrestrial network.

As shown in FIG. 2A, a non-terrestrial network may include a first satellite 211, a second satellite 212, a communication node 220, a gateway 230, a data network 240, and the like. The NTN shown in FIG. 2A may be a regenerative payload based NTN. For example, each of the satellites 211 and 212 may perform a regenerative operation (e.g. demodulation, decoding, re-encoding, re-modulation, and/or filtering operation) on a payload received from other entities (e.g. the communication node 220 or the gateway 230), and transmit the regenerated payload.

Each of the satellites 211 and 212 may be a LEO satellite, a MEO satellite, a GEO satellite, a HEO satellite, or a UAS platform. The UAS platform may include a HAPS. The satellite 211 may be connected to the satellite 212, and an inter-satellite link (ISL) may be established between the satellite 211 and the satellite 212. The ISL may operate in an RF frequency band or an optical band. The ISL may be established optionally. The communication node 220 may include a terrestrial communication node (e.g. UE or terminal) and a non-terrestrial communication node (e.g. airplane or drone). A service link (e.g. radio link) may be established between the satellite 211 and communication node 220. The satellite 211 may provide communication services to the communication node 220 using one or more beams.

The communication node 220 may perform communications (e.g. downlink communication or uplink communication) with the satellite 211 using the 4G communication technology, 5G communication technology, and/or 6G communication technology. The communications between the satellite 211 and the communication node 220 may be performed using an NR-Uu interface or 6G-Uu interface. When DC is supported, the communication node 220 may be connected to other base stations (e.g. base stations supporting 4G, 5G, and/or 6G functionality) as well as the satellite 211, and may perform DC operations based on the techniques defined in 4G, 5G, and/or 6G technical specifications.

The gateway 230 may be located on a terrestrial site, a feeder link may be established between the satellite 211 and the gateway 230, and a feeder link may be established between the satellite 212 and the gateway 230. The feeder link may be a radio link. When the ISL is not established between the satellite 211 and the satellite 212, the feeder link between the satellite 211 and the gateway 230 may be established mandatorily. The communications between each of the satellites 211 and 212 and the gateway 230 may be performed based on an NR-Uu interface, a 6G-Uu interface, or an SRI. The gateway 230 may be connected to the data network 240.

As shown in exemplary embodiments of FIG. 2B and FIG. 2C, there may be a ‘core network’ between the gateway 230 and the data network 240.

FIG. 2B is a conceptual diagram illustrating a fourth exemplary embodiment of a non-terrestrial network, and FIG. 2C is a conceptual diagram illustrating a fifth exemplary embodiment of a non-terrestrial network.

As shown in FIG. 2B and FIG. 2C, the gateway may be connected with the core network, and the core network may be connected with the data network. The core network may support the 4G communication technology, 5G communication technology, and/or 6G communication technology. For example. The core network may include AMF, UPF, SMF, and the like. Communication between the gateway and the core network may be performed based on an NG-C/U interface or 6G-C/U interface. Functions of a base station may be performed by the satellite. That is, the base station may be located on the satellite. A payload may be processed by the base station located on the satellite. Base stations located on different satellites may be connected to the same core network. One satellite may have one or more base stations. In the non-terrestrial network of FIG. 2B, an ISL between satellites may not be established, and in the non-terrestrial network of FIG. 2C, an ISL between satellites may be established.

Meanwhile, the entities (e.g. satellite, base station, UE, communication node, gateway, and the like) constituting the non-terrestrial network shown in FIGS. 1A, 1B, 2A, 2B, and/or 2C may be configured as follows. In the present disclosure, the entity may be referred to as a communication node.

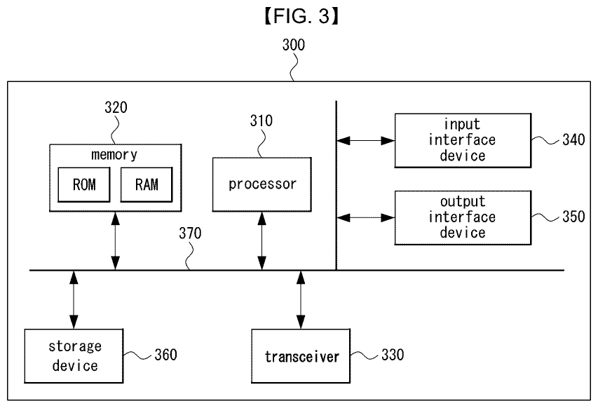

FIG. 3 is a block diagram illustrating a first exemplary embodiment of a communication node constituting a non-terrestrial network.

As shown in FIG. 3, a communication node 300 may include at least one processor 310, a memory 320, and a transceiver 330 connected to a network to perform communication. In addition, the communication node 300 may further include an input interface device 340, an output interface device 350, a storage device 360, and the like. The components included in the communication node 300 may be connected by a bus 370 to communicate with each other.

However, each component included in the communication node 300 may be connected to the processor 310 through a separate interface or a separate bus instead of the common bus 370. For example, the processor 310 may be connected to at least one of the memory 320, the transceiver 330, the input interface device 340, the output interface device 350, and the storage device 360 through a dedicated interface.

The processor 310 may execute at least one instruction stored in at least one of the memory 320 and the storage device 360. The processor 310 may refer to a central processing unit (CPU), a graphics processing unit (GPU), or a dedicated processor on which the methods according to the exemplary embodiments of the present disclosure are performed. Each of the memory 320 and the storage device 360 may be configured as at least one of a volatile storage medium and a nonvolatile storage medium. For example, the memory 320 may be configured with at least one of a read only memory (ROM) and a random access memory (RAM).

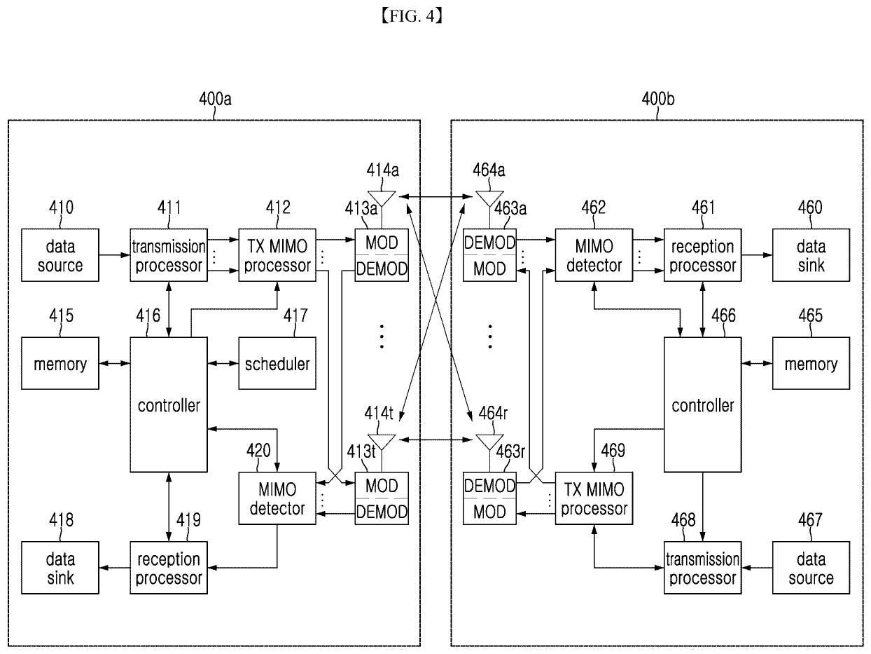

Meanwhile, communication nodes that perform communications in the communication network (e.g. non-terrestrial network) may be configured as follows. A communication node shown in FIG. 4 may be a specific exemplary embodiment of the communication node shown in FIG. 3.

FIG. 4 is a block diagram illustrating a first exemplary embodiment of communication nodes performing communication.

As shown in FIG. 4, each of a first communication node 400a and a second communication node 400b may be a base station or UE. The first communication node 400a may transmit a signal to the second communication node 400b. A transmission processor 411 included in the first communication node 400a may receive data (e.g. data unit) from a data source 410. The transmission processor 411 may receive control information from a controller 416. The control information may include at least one of system information, RRC configuration information (e.g. information configured by RRC signaling), MAC control information (e.g. MAC CE), or PHY control information (e.g. DCI, SCI).

The transmission processor 411 may generate data symbol(s) by performing processing operations (e.g. encoding operation, symbol mapping operation, etc.) on the data. The transmission processor 411 may generate control symbol(s) by performing processing operations (e.g. encoding operation, symbol mapping operation, etc.) on the control information. In addition, the transmission processor 411 may generate synchronization/reference symbol(s) for synchronization signals and/or reference signals.

A Tx MIMO processor 412 may perform spatial processing operations (e.g. precoding operations) on the data symbol(s), control symbol(s), and/or synchronization/reference symbol(s). An output (e.g. symbol stream) of the Tx MIMO processor 412 may be provided to modulators (MODs) included in transceivers 413a to 413t. The modulator may generate modulation symbols by performing processing operations on the symbol stream, and may generate signals by performing additional processing operations (e.g. analog conversion operations, amplification operation, filtering operation, up-conversion operation, etc.) on the modulation symbols. The signals generated by the modulators of the transceivers 413a to 413t may be transmitted through antennas 414a to 414t.

The signals transmitted by the first communication node 400a may be received at antennas 464a to 464r of the second communication node 400b. The signals received at the antennas 464a to 464r may be provided to demodulators (DEMODs) included in transceivers 463a to 463r. The demodulator (DEMOD) may obtain samples by performing processing operations (e.g. filtering operation, amplification operation, down-conversion operation, digital conversion operation, etc.) on the signals. The demodulator may perform additional processing operations on the samples to obtain symbols. A MIMO detector 462 may perform MIMO detection operations on the symbols. A reception processor 461 may perform processing operations (e.g. de-interleaving operation, decoding operation, etc.) on the symbols. An output of the reception processor 461 may be provided to a data sink 460 and a controller 466. For example, the data may be provided to the data sink 460 and the control information may be provided to the controller 466.

On the other hand, the second communication node 400b may transmit signals to the first communication node 400a. A transmission processor 469 included in the second communication node 400b may receive data (e.g. data unit) from a data source 467 and perform processing operations on the data to generate data symbol(s). The transmission processor 468 may receive control information from the controller 466 and perform processing operations on the control information to generate control symbol(s). In addition, the transmission processor 468 may generate reference symbol(s) by performing processing operations on reference signals.

A Tx MIMO processor 469 may perform spatial processing operations (e.g. precoding operations) on the data symbol(s), control symbol(s), and/or reference symbol(s). An output (e.g. symbol stream) of the Tx MIMO processor 469 may be provided to modulators (MODs) included in the transceivers 463a to 463t. The modulator may generate modulation symbols by performing processing operations on the symbol stream, and may generate signals by performing additional processing operations (e.g. analog conversion operation, amplification operation, filtering operation, up-conversion operations) on the modulation symbols. The signals generated by the modulators of the transceivers 463a to 463t may be transmitted through the antennas 464a to 464t.

The signals transmitted by the second communication node 400b may be received at the antennas 414a to 414r of the first communication node 400a. The signals received at the antennas 414a to 414r may be provided to demodulators (DEMODs) included in the transceivers 413a to 413r. The demodulator may obtain samples by performing processing operations (e.g. filtering operation, amplification operation, down-conversion operation, digital conversion operation) on the signals. The demodulator may perform additional processing operations on the samples to obtain symbols. A MIMO detector 420 may perform a MIMO detection operation on the symbols. The reception processor 419 may perform processing operations (e.g. de-interleaving operation, decoding operation, etc.) on the symbols. An output of the reception processor 419 may be provided to a data sink 418 and the controller 416. For example, the data may be provided to the data sink 418 and the control information may be provided to the controller 416.

Memories 415 and 465 may store the data, control information, and/or program codes. A scheduler 417 may perform scheduling operations for communication. The processors 411, 412, 419, 461, 468, and 469 and the controllers 416 and 466 shown in FIG. 4 may be the processor 310 shown in FIG. 3, and may be used to perform methods described in the present disclosure.

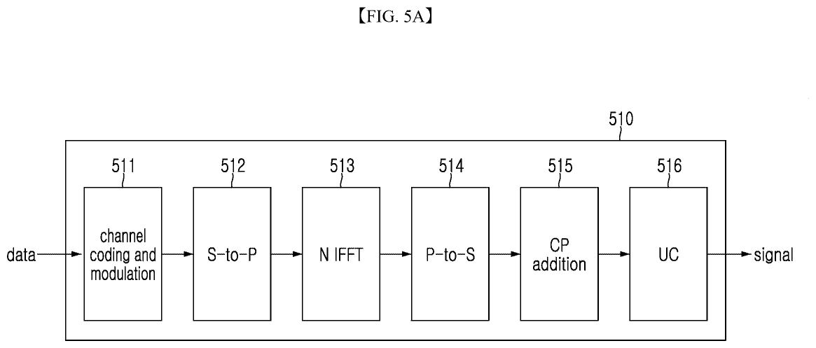

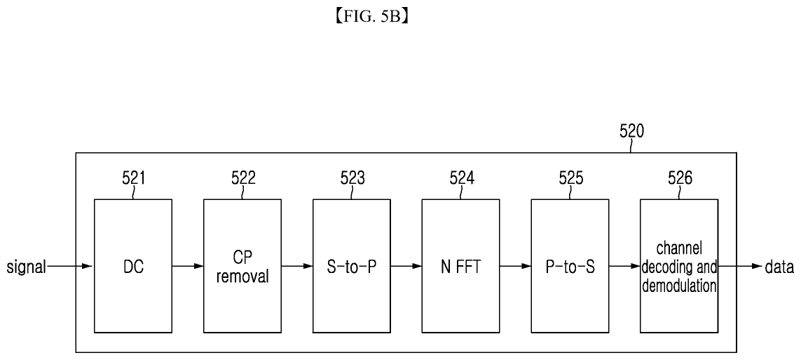

FIG. 5A is a block diagram illustrating a first exemplary embodiment of a transmission path, and FIG. 5B is a block diagram illustrating a first exemplary embodiment of a reception path.

As shown in FIGS. 5A and 5B, a transmission path 510 may be implemented in a communication node that transmits signals, and a reception path 520 may be implemented in a communication node that receives signals. The transmission path 510 may include a channel coding and modulation block 511, a serial-to-parallel (S-to-P) block 512, an N-point inverse fast Fourier transform (N-point IFFT) block 513, a parallel-to-serial (P-to-S) block 514, a cyclic prefix (CP) addition block 515, and up-converter (UC) 516. The reception path 520 may include a down-converter (DC) 521, a CP removal block 522, an S-to-P block 523, an N-point FFT block 524, a P-to-S block 525, and a channel decoding and demodulation block 526. Here, N may be a natural number.

In the transmission path 510, information bits may be input to the channel coding and modulation block 511. The channel coding and modulation block 511 may perform a coding operation (e.g. low-density parity check (LDPC) coding operation, polar coding operation, etc.) and a modulation operation (e.g. Quadrature Phase Shift Keying (OPSK), Quadrature Amplitude Modulation (QAM), etc.) on the information bits. An output of the channel coding and modulation block 511 may be a sequence of modulation symbols.

The S-to-P block 512 may convert frequency domain modulation symbols into parallel symbol streams to generate N parallel symbol streams. N may be the IFFT size or the FFT size. The N-point IFFT block 513 may generate time domain signals by performing an IFFT operation on the N parallel symbol streams. The P-to-S block 514 may convert the output (e.g., parallel signals) of the N-point IFFT block 513 to serial signals to generate the serial signals.

The CP addition block 515 may insert a CP into the signals. The UC 516 may up-convert a frequency of the output of the CP addition block 515 to a radio frequency (RF) frequency. Further, the output of the CP addition block 515 may be filtered in baseband before the up-conversion.

The signal transmitted from the transmission path 510 may be input to the reception path 520. Operations in the reception path 520 may be reverse operations for the operations in the transmission path 510. The DC 521 may down-convert a frequency of the received signals to a baseband frequency. The CP removal block 522 may remove a CP from the signals. The output of the CP removal block 522 may be serial signals. The S-to-P block 523 may convert the serial signals into parallel signals. The N-point FFT block 524 may generate N parallel signals by performing an FFT algorithm. The P-to-S block 525 may convert the parallel signals into a sequence of modulation symbols. The channel decoding and demodulation block 526 may perform a demodulation operation on the modulation symbols and may restore data by performing a decoding operation on a result of the demodulation operation.

In FIGS. 5A and 5B, discrete Fourier transform (DFT) and inverse DFT (IDFT) may be used instead of FFT and IFFT. Each of the blocks (e.g. components) in FIGS. 5A and 5B may be implemented by at least one of hardware, software, or firmware. For example, some blocks in FIGS. 5A and 5B may be implemented by software, and other blocks may be implemented by hardware or a combination of hardware and software. In FIGS. 5A and 5B, one block may be subdivided into a plurality of blocks, a plurality of blocks may be integrated into one block, some blocks may be omitted, and blocks supporting other functions may be added.

Meanwhile, NTN reference scenarios may be defined as shown in Table 1 below.

TABLE 1

| | NTN shown | NTN shown |
|---|---|---|
| | in FIG. 1 | in FIG. 2 |
| GEO | Scenario A | Scenario B |
| LEO (steerable | Scenario C1 | Scenario D1 |
| beams) | | |
| LEO (beams | Scenario C2 | Scenario D2 |
| moving with | | |
| satellite) | | |

When the satellite 110 in the NTN shown in FIG. 1A and/or FIG. 1B is a GEO satellite (e.g. a GEO satellite that supports a transparent function), this may be referred to as ‘scenario A’. When the satellites 211 and 212 in the NTN shown in FIG. 2A, FIG. 2B, and/or FIG. 2C are GEO satellites (e.g. GEOs that support a regenerative function), this may be referred to as ‘scenario B’. When the satellite 110 in the NTN shown in FIG. 1A and/or FIG. 1B is an LEO satellite with steerable beams, this may be referred to as ‘scenario C1’. When the satellite 110 in the NTN shown in FIG. 1A and/or FIG. 1B is an LEO satellite having beams moving with the satellite, this may be referred to as ‘scenario C2’. When the satellites 211 and 212 in the NTN shown in FIG. 2A, FIG. 2B, and/or FIG. 2C are LEO satellites with steerable beams, this may be referred to as ‘scenario D1’. When the satellites 211 and 212 in the NTN shown in FIG. 2A, FIG. 2B, and/or FIG. 2C are LEO satellites having beams moving with the satellites, this may be referred to as ‘scenario D2’.

Parameters for the NTN reference scenarios defined in Table 1 may be defined as shown in Table 2 below.

TABLE 2

| | Scenarios A and B | Scenarios C and D |
|---|---|---|
| Altitude | 35,786 km | 600 km |
| | | 1,200 km |
| Spectrum (service | <6 GHz (e.g. 2 GHz) | |
| link) | >6 GHz (e.g. DL 20 GHz, UL 30 GHz) | |
| Maximum channel | 30 MHz for band <6 GHz | |
| bandwidth capability | 1 GHz for band >6 GHz | |
| (service link) | | |
| Maximum distance | 40,581 km | 1,932 km (altitude |
| between satellite | | of 600 km) |
| and communication | | 3,131 km (altitude |
| node (e.g. UE) at | | of 1,200 km) |
| the minimum | | |
| elevation angle | | |
| Maximum round trip | Scenario A: 541.46 ms | Scenario C: |
| delay (RTD) | (service and feeder | (transparent payload: |
| (only propagation | links) | service and feeder |
| delay) | Scenario B: 270.73 ms | links) |
| | (only service link) | −5.77 ms (altitude |
| | | of 60 0 km) |
| | | −41.77 ms (altitude |
| | | of 1,200 km) |
| | | Scenario D: |
| | | (regenerative payload: |
| | | only service link) |
| | | −12.89 ms (altitude |
| | | of 600 km) |
| | | −20.89 ms (altitude |
| | | of 1,200 km) |
| Maximum | 10.3 ms | 3.12 ms (altitude of |
| differential delay | | 600 km) |
| within a cell | | 3.18 ms (altitude of |
| | | 1,200 km) |

| | |
|---|---|
| Service link | NR defined in 3GPP |
| Feeder link | Radio interfaces defined in 3GPP or non-3GPP |

In addition, in the scenarios defined in Table 1, delay constraints may be defined as shown in Table 3 below.

TABLE 3

| | Scenario A | Scenario B | Scenario C1-2 | Scenario D1-2 |
|---|---|---|---|---|
| Satellite altitude | 35,786 km | | 600 km | |
| Maximum RTD in a | 541.75 ms | 270.57 ms | 28.41 ms | 12.88 ms |
| radio interface | (worst case) | | | |
| between base | | | | |
| station and UE | | | | |
| Minimum RTD in a | 477.14 ms | 238.57 ms | 8 ms | 4 ms |
| radio interface | | | | |
| between base | | | | |
| station and UE | | | | |

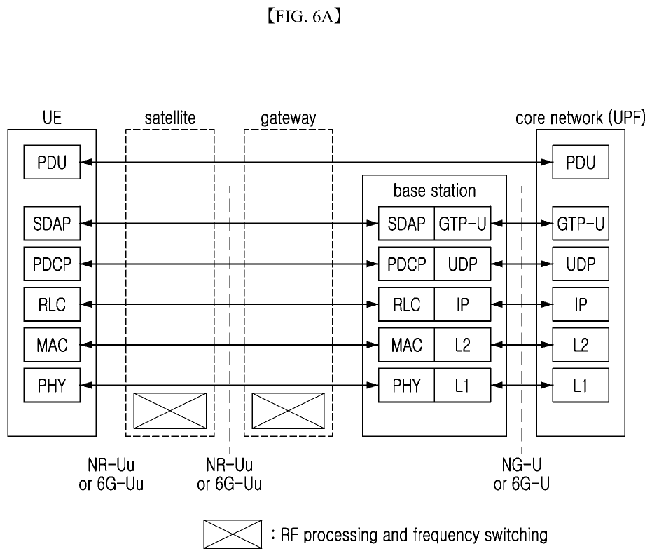

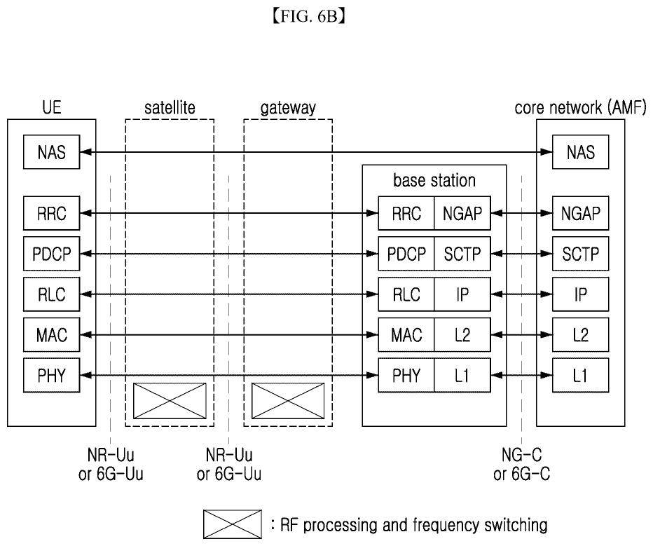

FIG. 6A is a conceptual diagram illustrating a first exemplary embodiment of a protocol stack of a user plane in a transparent payload-based non-terrestrial network, and FIG. 6B is a conceptual diagram illustrating a first exemplary embodiment of a protocol stack of a control plane in a transparent payload-based non-terrestrial network.

As shown in FIGS. 6A and 6B, user data may be transmitted and received between a UE and a core network (e.g. UPF), and control data (e.g. control information) may be transmitted and received between the UE and the core network (e.g. AMF). Each of the user data and the control data may be transmitted and received through a satellite and/or gateway. The protocol stack of the user plane shown in FIG. 6A may be applied identically or similarly to a 6G communication network. The protocol stack of the control plane shown in FIG. 6B may be applied identically or similarly to a 6G communication network.

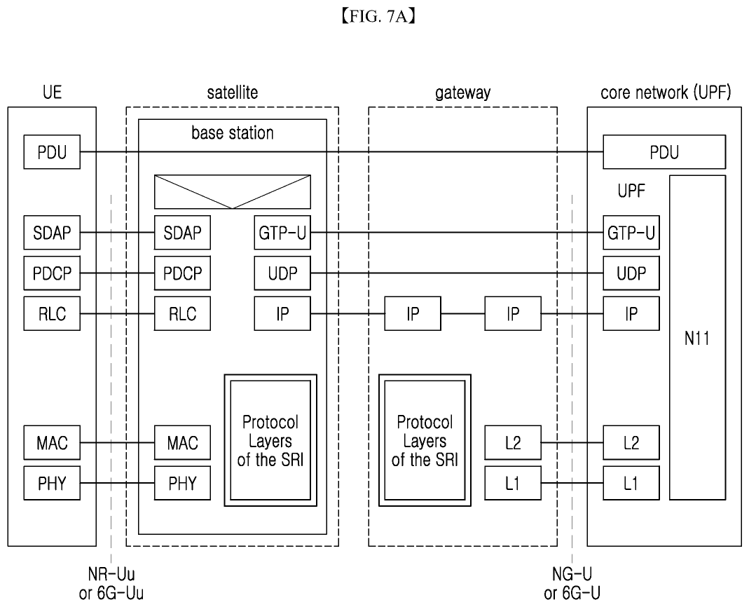

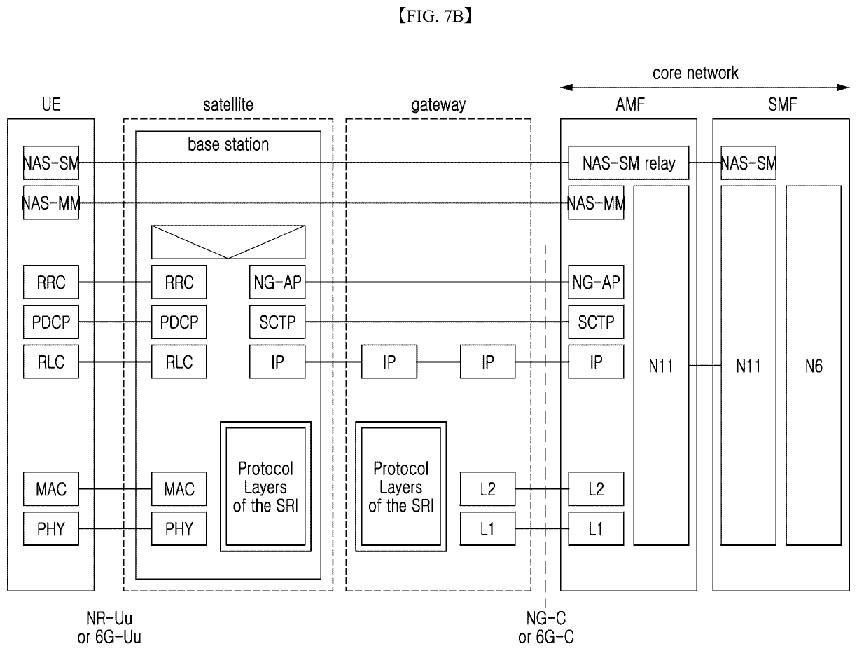

FIG. 7A is a conceptual diagram illustrating a first exemplary embodiment of a protocol stack of a user plane in a regenerative payload-based non-terrestrial network, and FIG. 7B is a conceptual diagram illustrating a first exemplary embodiment of a protocol stack of a control plane in a regenerative payload-based non-terrestrial network.

As shown in FIGS. 7A and 7B, each of user data and control data (e.g. control information) may be transmitted and received through an interface between a UE and a satellite (e.g. base station). The user data may refer to a user protocol data unit (PDU). A protocol stack of a satellite radio interface (SRI) may be used to transmit and receive the user data and/or control data between the satellite and a gateway. The user data may be transmitted and received through a general packet radio service (GPRS) tunneling protocol (GTP)-U tunnel between the satellite and a core network.

Meanwhile, in a non-terrestrial network, a base station may transmit system information (e.g. SIB19) including satellite assistance information for NTN access. A UE may receive the system information (e.g. SIB19) from the base station, identify the satellite assistance information included in the system information, and perform communication (e.g. non-terrestrial communication) based on the satellite assistance information. The SIB319 may include information element(s) defined in Table 4 below.

TABLE 4
SIB19-r17 ::= SEQUENCE {

| | |
|---|---|
| ntn-Config-r17 | NTN-Config-r17 |
| t-Service-r17 | INTEGER(0..549755813887) |
| referenceLocation-r17 | ReferenceLocation-r17 |
| distanceThresh-r17 | INTEGER(0..65525) |
| ntn-NeighCellConfigList-r17 | NTN-NeighCellConfigList-r17 |
| lateNonCriticalExtension | OCTET STRING |

```
  ...,
  [[
```

| | |
|---|---|
| ntn-NeighCellConfigListExt-v1720 | NTN-NeighCellConfigList-r17 |

]]
}

| | |
|---|---|
| NTN-NeighCellConfigList-r17 ::= | SEQUENCE |

(SIZE(1..maxCelINTN-r17)) OF NTN-NeighCellConfig-r17

| | |
|---|---|
| NTN-NeighCellConfig-r17 ::= | SEQUENCE { |
| ntn-Config-r17 | NTN-Config-r17 |
| carrierFreq-r17 | ARFCN-ValueNR |
| physCellId-r17 | PhysCellId |
| } | |

NTN-Config defined in Table 4 may include information element(s) defined in Table 5 below.

TABLE 5

| | |
|---|---|
| NTN-Config-r17 ::= | SEQUENCE { |
| epochTime-r17 | EpochTime-r17 |

ntn-UlSyncValidityDuration-r17 ENUMERATED{ s5, s10, s15, s20,
s25, s30, s35, s40, s45, s50, s55, s60, s120, s180, s240, s900}

| | |
|---|---|
| cellSpecificKoffset-r17 | INTEGER(1..1023) |
| kmac-r17 | INTEGER(1..512) |
| ta-Info-r17 | TA-Info-r17 |
| ntn-PolarizationDL-r17 | ENUMERATED {rhcp,lhcp,linear} |
| ntn-PolarizationUL-r17 | ENUMERATED {rhcp,lhcp,linear} |
| ephemerisInfo-r17 | EphemerisInfo-r17 |
| ta-Report-r17 | ENUMERATED {enabled} |

...
}

| | |
|---|---|
| EpochTime-r17 ::= | SEQUENCE { |
| sfn-r17 | INTEGER(0..1023), |
| subFrameNR-r17 | INTEGER(0..9) |

}

| | |
|---|---|
| TA-Info-r17 ::= | SEQUENCE { |
| ta-Common-r17 | INTEGER(0..66485757), |
| ta-CommonDrift-r17 | INTEGER(−257303..257303) |
| ta-CommonDriftVariant-r17 | INTEGER(0..28949) |

}

EphemerisInfo defined in Table 5 may include information element(s) defined in Table 6 below.

TABLE 6

| | |
|---|---|
| EphemerisInfo-r17 ::= | CHOICE { |
| positionVelocity-r17 | PositionVelocity-r17, |
| orbital-r17 | Orbital-r17 |

}

| | |
|---|---|
| PositionVelocity-r17 ::= | SEQUENCE { |
| positionX-r17 | PositionStateVector-r17, |
| positionY-r17 | PositionStateVector-r17, |
| positionZ-r17 | PositionStateVector-r17, |
| velocityVX-r17 | VelocityStateVector-r17, |
| velocityVY-r17 | VelocityStateVector-r17, |
| velocityVZ-r17 | VelocityStateVector-r17 |

}

| | |
|---|---|
| Orbital-r17 ::= | SEQUENCE { |
| semiMajorAxis-r17 | INTEGER (0..8589934591), |
| eccentricity-r17 | INTEGER (0..1048575), |
| periapsis-r17 | INTEGER (0..268435455), |
| longitude-r17 | INTEGER (0.268435455), |
| inclination-r17 | INTEGER (−67108864..67108863), |
| meanAnomaly-r17 | INTEGER (0..268435455) |

}
PositionStateVector-r17 ::= INTEGER (−33554432..33554431)
VelocityStateVector-r17 ::= INTEGER (−131072..131071)

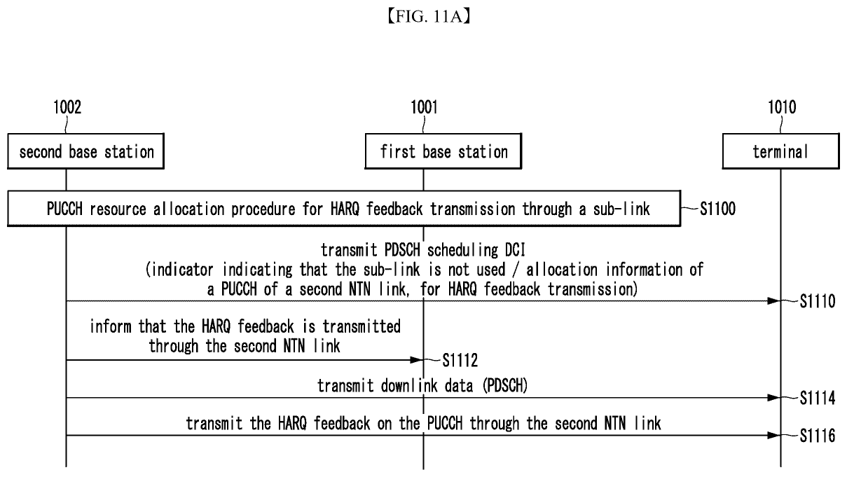

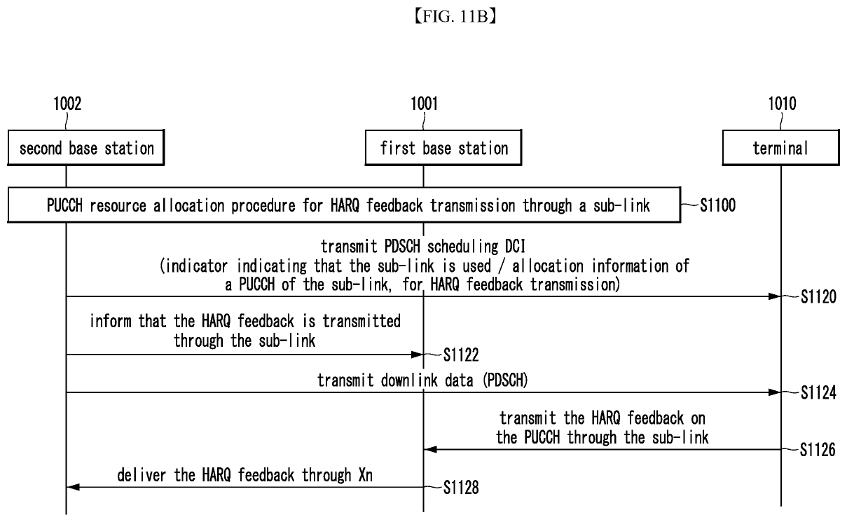

Meanwhile, a satellite of 3GPP NTN may be classified into a transparent satellite described above in FIGS. 1A and 11B and a regenerative satellite in FIGS. 2A and 2B depending on functions of the satellite.

### [NTN Configuration According to Satellite Functions]

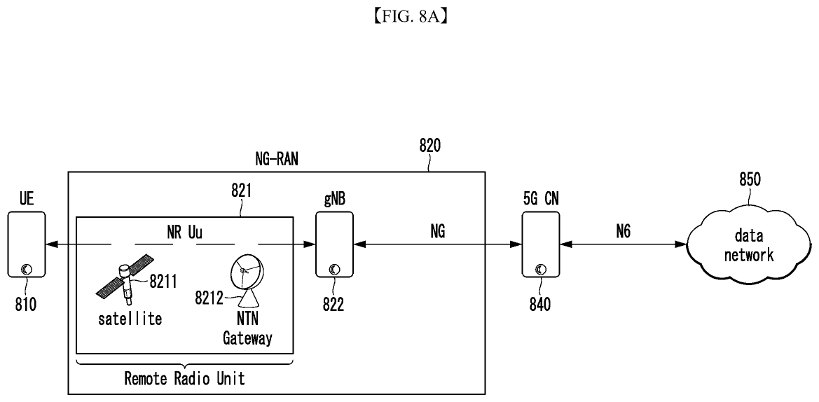

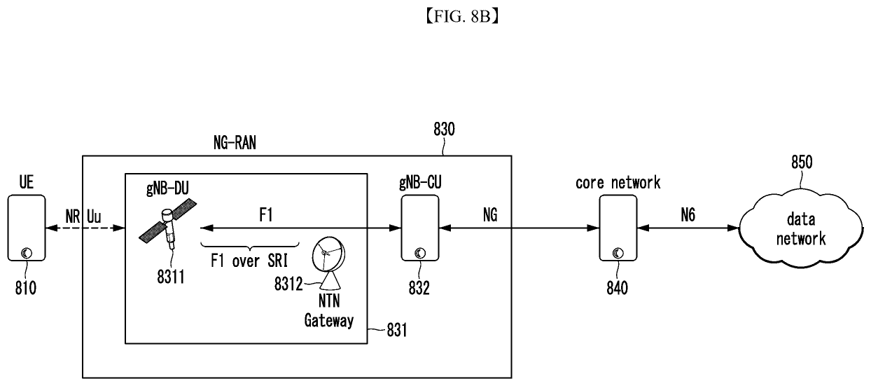

Network configurations using these satellites will be described in more detail with reference to FIGS. 8A and 8B.

FIG. 8A is a conceptual diagram illustrating a configuration of a non-terrestrial network according to a first exemplary embodiment, and FIG. 8B is a conceptual diagram illustrating a configuration of a non-terrestrial network according to a second exemplary embodiment.

As shown in FIG. 8A, a configuration according to a first exemplary embodiment of a non-terrestrial network may include a terminal 810, an access network 820 for performing wireless communication according to the 5G NTN standard specifications, and a core network (CN) 840 and a data network (DN) 850 according to the 5G standard specifications.

The terminal 810 may be a user equipment (UE) specified in the 5G standard specifications, and may be a communication node capable of terrestrial network (TN) communication and non-terrestrial network (NTN) communication. The communication node may have the configuration previously described in FIG. 3.

The 5G core network 840 based on the 5G standard may include a user plane function (UPF) that transmits and receives data with the UE 810, an access and mobility management function (AMF) that manages access and mobility of the UE 810, a session management function (SMF) that manages sessions, a policy control function (PCF) that controls policies of the 5G core network, and a network exposure function (NEF) that exposes the 5G core network 840 to a specific server of the data network 850.

The data network 850 may include the Internet or a specific-purpose data server, and may be connected to the 5G core network via the UPF using the NEF or the like. The data network 850 may transmit or receive data to or from the UE 810 via the UPF.

Since the data network 850 and the 5G core network 840 are not important elements in the present disclosure, additional detailed description thereon will be omitted.

The next generation-radio access network (NG-RAN) 820, where wireless communication occurs, may include a base station 822 and a remote radio unit (RRU) 921. The base station 822 (e.g. gNB according to the 5G communication specifications) may transmit and receive signals with the UE 810 through a radio interface (i.e. NR Uu) via an NTN gateway 8212 and a satellite 8211.

In addition, the NTN gateway 8212 located on the ground may be connected to the base station 822 by wire or wirelessly, and may be installed at the same location as the base station 822 in a specific case. The transparent satellite 8211 orbiting a specific orbit of the Earth illustrated in FIG. 8A may be a satellite that receives a signal transmitted by the NTN gateway 8212 or a signal transmitted by the UE 810, simply amplifies it, and transmits the amplified signal to the UE 810 or the NTN gateway 8212.

Meanwhile, as previously described in FIGS. 1A and 1B, a link between the terminal 810 and the satellite 8211 may be referred to as a service link, and a link between the satellite 8211 and the NTN gateway 8212 may be referred to as a feeder link. In the present disclosure described below, the NTN gateway may not occupy an important part. Therefore, except for special cases in the following description, the base station (e.g. gNB) may be understood as either including the gateway or being connected to the gateway, and the base station (e.g. gNB) will be described as including the gateway. In the NTN, data transmission and reception to and from the terminal (e.g. UE 810), as well as the associated scheduling function, may be performed by the gNB 822 on the ground, and the satellite may perform a relay function between the terminal 810 and the gNB 822.

Next, a configuration shown in FIG. 8B will be described. Comparing FIG. 8B with FIG. 8A, the difference lies in the NG-RAN 830 where wireless communication occurs, while all other components remain the same. Therefore, in FIG. 8B, only components that are different from those of FIG. 8A will be described.

The NG-RAN 830 where wireless communication occurs may include a base station 832 (e.g. gNB), a regenerative satellite 8311 orbiting a specific orbit of the Earth for NTN communication, and an NTN gateway 8312 on the ground.

Since the regenerative satellite 8311 may be a distributed unit (DU) because it regenerates received data and transmits it to the UE 810 or the NTN gateway 8312. Since the regenerative satellite 8311 corresponds to a DU, the base station 832 may correspond to a centralized unit (CU). In addition, since the regenerative satellite 8311 corresponds to a DU and the base station 832 corresponds to a CU, the base station 832 may perform data transmission/reception to and from the UE 810 and a scheduling function therefor.

Further, since the base station 832 operates as a CU and the regenerative satellite 8311 operates as a DU, the base station 832 and the regenerative satellite 8311 may be connected using an F1 interface. Signals may be transmitted and received between the regenerative satellite 8311 and the UE 810 through a radio interface (i.e. NR Uu) based on the 5G NTN standard.

### [Various Examples of Multi-Link Environments]

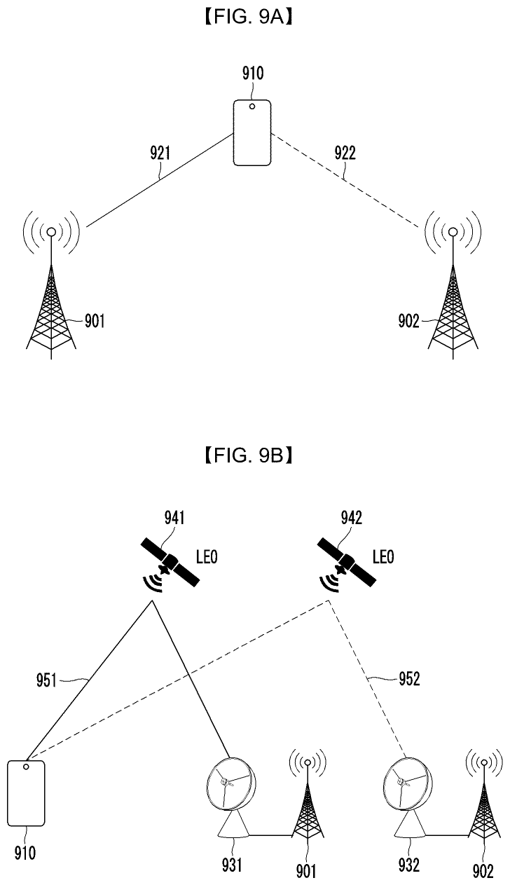

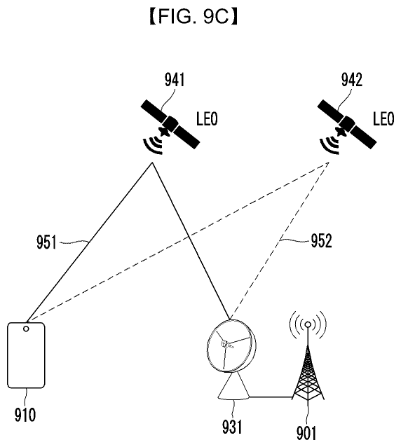

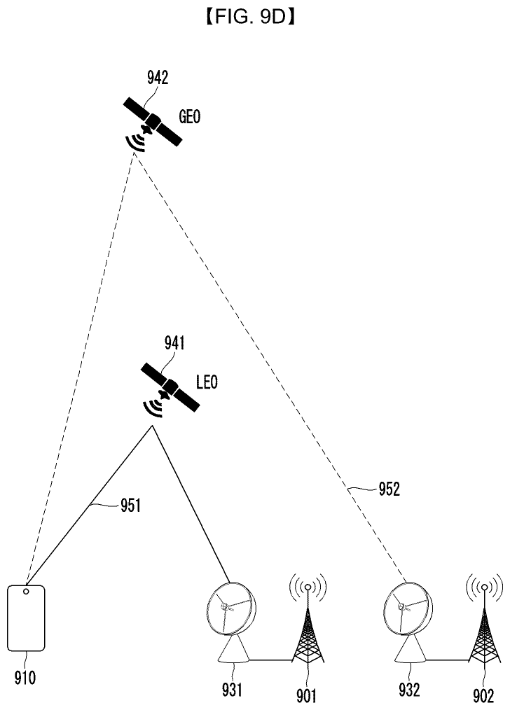

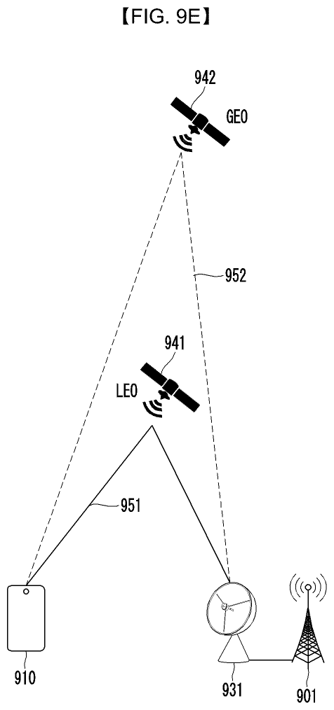

The present disclosure will describe methods for HARQ operations in a multi-link environment, for example, a multi-connectivity environment and a multi-TRP environment. Therefore, various types of multi-link environments will be described with reference to FIGS. 9A to 9E.

FIG. 9A is a conceptual diagram illustrating a case where one terminal is in a state of dual connectivity with two different TNs.

As shown in FIG. 9A, a terminal 910 and two different base stations 901 and 902 are illustrated. The terminal 910 may establish a first wireless link 921 with the first base station 901, and the terminal 910 may establish a second wireless link 922 with the second base station 902. Here, both the first wireless link 921 and the second wireless link 922 may be used to transmit and receive signals through radio interfaces (i.e. NR Uu) defined in the 5G communication standard. Therefore, since the terminal 910 may transmit/receive signals with the first base station 901 through the first wireless link 921, and may transmit/receive signals with the second base station 902 through the second wireless link 922, it may be expected that propagation delays of the first wireless link 921 and the second wireless link 922 do exceed a single unit of an OFDM symbol.

In FIG. 9A, the first wireless link 921 is indicated with a solid line and the second wireless link 922 is indicated with a dotted line to distinguish the links connected to different base stations.

FIG. 9B is a conceptual diagram illustrating a case where one terminal is in a state of dual connectivity with an NTN comprising two different LEO satellites.

As shown in FIG. 9B, a first NTN link 951 may be composed of a terminal 910, a first satellite 941, a first gateway 931, and a first base station 901, and a second NTN link 952 may be composed of the terminal 910, a second satellite 942, a second gateway 932, and a second base station 902. In FIG. 9B, the first NTN link 951 is indicated with a solid line and the second NTN link 925 is indicated with a dotted line to distinguish the links connected to different satellites.

As described above, the first NTN link 951 may include a service link between the terminal 910 and the first satellite 941 and a feeder link between the first satellite 941 and the first gateway 931. In addition, the second NTN link 952 may include a service link between the terminal 910 and the second satellite 942 and a feeder link between the second satellite 942 and the second gateway 932.

The first gateway 931 and the first base station 901 may be connected by wire or wirelessly as previously described in FIGS. 8A and 8B, and may be installed at the same location as the first base station 901 in a specific case. The second gateway 932 and the second base station 902 may also be connected by wire or wirelessly, and may be installed at the same location as the first base station 901 in a specific case.

A difference between latencies of the first NTN link 951 and the second NTN link 952 may vary depending on the location of the terminal 910, the locations of the satellites 941 and 942, and the locations of the gateways 931 and 932 on the ground. In particular, the difference between latencies may be large or small depending on the locations of the satellites 941 and 942.

As described above, since the terminal 910 is connected to the different satellites 941 and 942, respectively, and the satellites 941 and 942 are connected to different base stations 901 and 902 via different gateways 931 and 932, respectively, the terminal 910 may be in a state of multi-connectivity with the different base stations 901 and 902 via the different satellites 941 and 942.

FIG. 9C is a conceptual diagram illustrating a case where one terminal is connected to two different LEO satellites operating as multiple TRPs.

As shown in FIG. 9C, the first NTN link 951 may be composed of the terminal 910, the first satellite 941, the gateway 931, and the base station 901, and the second NTN link 952 may be composed of the terminal 910, the second satellite 942, the gateway 931, and the base station 901. In FIG. 9C, the first NTN link 951 is indicated with a solid line and the second NTN link 925 is indicated with a dotted line to distinguish the links using different satellites.

As described above, the first NTN link 951 may include a service link between the terminal 910 and the first satellite 941 and a feeder link between the first satellite 941 and the gateway 931. In addition, the second NTN link 952 may include a service link between the terminal 910 and the second satellite 942 and a feeder link between the second satellite 942 and the gateway 931.

The gateway 931 and the base station 901 may be connected by wire or wirelessly as previously described in FIGS. 8A and 8B, and may be installed at the same location as the base station 901 in a specific case.

A difference between latencies of the first NTN link 951 and the second NTN link 952 may vary depending on the location of the terminal 910, the locations of the satellites 941 and 942, and the location of the gateway 931 on the ground. In the case of FIG. 9C, the gateway may be fixed to a specific location on the ground, and a moving speed of the terminal may be significantly slower than those of the satellites. Accordingly, the difference between the latencies of the first NTN link 951 and the second NTN link 952 may be large or small depending on the locations of the satellites 941 and 942.

As described above, the terminal 910 may be connected to the different satellites 941 and 942, respectively, and the satellites 941 and 942 may be connected to one base station 901 via one gateway 931. Therefore, the different satellites 941 and 942 may each operate as a TRP. Accordingly, the configuration of FIG. 9C may correspond to a case where the LEO satellites operate as multiple TRPs for one terminal.

FIG. 9D is a conceptual diagram illustrating a case where one terminal is connected to satellites at different altitudes.

As shown in FIG. 9D, the first NTN link 951 may be composed of the terminal 910, the first satellite 941, the first gateway 931, and the first base station 901, and the second NTN link 952 may be composed of the terminal 910, the second satellite 942, the second gateway 932, and the second base station 902. In FIG. 9D, the first satellite 941 may be a LEO satellite, and the second satellite 942 may be a GEO satellite. Also, in FIG. 9D, the first NTN link 951 is indicated with a solid line and the second NTN link 925 is indicated with a dotted line to distinguish between the links using different satellites.

As described above, the first NTN link 951 may include a service link between the terminal 910 and the first satellite 941 and a feeder link between the first satellite 941 and the first gateway 931. In addition, the second NTN link 952 may include a service link between the terminal 910 and the second satellite 942 and a feeder link between the second satellite 942 and the second gateway 932.

The first gateway 931 and the first base station 901 may be connected by wire or wirelessly as previously described in FIGS. 8A and 8B, and may be installed at the same location as the first base station 901 in a specific case. The second gateway 932 and the second base station 902 may also be connected by wire or wirelessly, and may be installed at the same location as the first base station 901 in a specific case.

Comparing latencies of the first NTN link 951 and the second NTN link 952, the latency of the second NTN link 952 may be always longer than that of the first NTN link. This is because GEO satellites are located at a very high altitude compared to LEO satellites. In other words, this is because a delay of the service link between the terminal 910 and the second satellite 942 constituting the second NTN link 952 is much longer than a delay of the service link between the terminal 910 and the first satellite 941, and a delay of the feeder link between the second satellite 942 and the second gateway 932 is much longer than a delay of the feeder link between the first satellite 941 and the first gateway 931.

In the case of FIG. 9D, as previously described in FIG. 9B, since the terminal 910 is connected to different satellites 941 and 942, respectively, and the satellites 941 and 942 are connected to the different base stations 901 and 902 via different satellites 941 and 942, respectively, the terminal 910 may be in a state of multi-connectivity with the different base stations 901 and 902 via the different satellites 941 and 942.

FIG. 9E is a conceptual diagram illustrating a case where one terminal is connected to satellites at different altitudes operating as multiple TRPs.

As shown in FIG. 9E, the first NTN link 951 may be composed of the terminal 910, the first satellite 941, the gateway 931, and the base station 901, and the second NTN link 952 may be composed of the terminal 910, the second satellite 942, the gateway 931, and the base station 901. In FIG. 9E, the first NTN link 951 is indicated with a solid line and the second NTN link 925 is indicated with a dotted line to distinguish the links using different satellites.

As described above, the first NTN link 951 may include a service link between the terminal 910 and the first satellite 941 and a feeder link between the first satellite 941 and the gateway 931. In addition, the second NTN link 952 may include a service link between the terminal 910 and the second satellite 942 and a feeder link between the second satellite 942 and the gateway 931.

The gateway 931 and the base station 901 may be connected by wire or wirelessly as previously described in FIGS. 8A and 8B, and may be installed at the same location as the base station 901 in a specific case.

Comparing latencies of the first NTN link 951 and the second NTN link 952, the latency of the second NTN link 952 may be always longer than that of the first NTN link 951. This is because GEO satellites are located at a very high altitude compared to LEO satellites. In other words, this is because a delay of the service link between the terminal 910 and the second satellite 942 constituting the second NTN link 952 is much longer than a delay of the service link between the terminal 910 and the first satellite 941, and a delay of the feeder link between the second satellite 942 and the second gateway 932 is much longer than a delay of the feeder link between the first satellite 941 and the first gateway 931.

In FIG. 9E, as previously described in FIG. 9C, the terminal 910 may be connected to different satellites 941 and 942, respectively, and the satellites 941 and 942 may be connected to one base station 901 via one gateway 931. Accordingly, each of the different satellites 941 and 942 may operate as a TRP. Therefore, the configuration of FIG. 9E may correspond to a case where the LEO satellite and GEO satellite operates as multiple TRPs for one terminal.

Among the examples of FIGS. 9A to 9E described above, in multi-link environments including the NTN, which are illustrated in FIGS. 9B to 9E, a large difference in propagation delays may occur. In this case, actively utilizing a relatively short NTN link among the different NTN links may increase system efficiency in many aspects, including data transmission and retransmission. For example, even when initial transmission of data is performed over a long link, an HARQ feedback for the data may be transmitted using a short link. This operation can reduce a time required for the base station of the long link to wait for the HARQ feedback. In addition, if retransmission of data for which a negative acknowledgment (NACK) occurs is performed through the short link, the terminal may be able to receive and decode the data at an earlier timing.

In addition to the cases illustrated in FIGS. 9A to 9E, there may be a multi-connectivity configuration in which TN and NTN are mixed. Even in the case of multi-connectivity configuration in which TN and NTN are mixed, a difference in latencies experienced by the two links may be very large. The case where TN and NTN are mixed may be understood as similar to the case where the NTN link of LEO satellite and the NTN link of GEO satellite are mixed as described in FIGS. 9D and 9E. Therefore, proposed methods described below may be applied also to the multi-connectivity configuration where TN and NTN are mixed.

### [Multi-Link Environment and a Sub-Link in NTN]

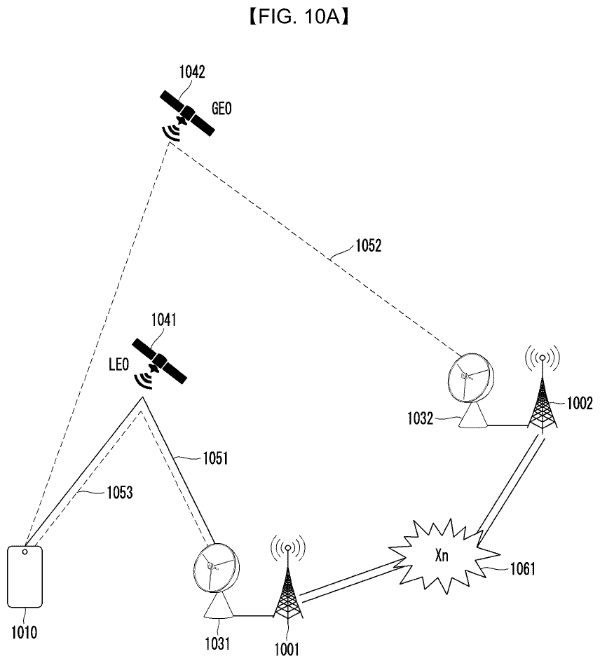

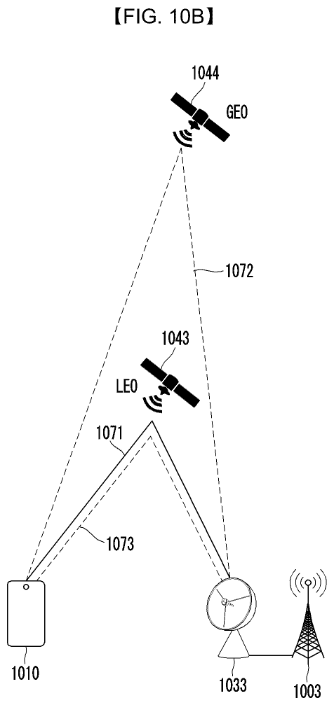

FIG. 10A is a conceptual diagram illustrating configuration of an HARQ feedback link when one terminal is in a state of multi-connectivity with satellites at different altitudes according to a first exemplary embodiment of the present disclosure.

As shown in FIG. 10A, a first NTN link 1051 may be composed of a terminal 1010, a first satellite 1041, a first gateway 1031, and a first base station 1001, and a second NTN link 1052 may be composed of the terminal 1010, a second satellite 1042, a second gateway 1032, and a second base station 1002. A third NTN link 1053, which operates as a sub-link, may be configured with the same path as the first NTN link 1051. However, the third NTN link 1053 may be used as a path to transmit an HARQ feedback and/or retransmission data according to the present disclosure. The third NTN link 1053 according to the present disclosure may be configured as a separate channel different from the first NTN link 1051, or may be implemented as a portion of the first NTN link 1051. In the present disclosure, the ‘separate channel’ may refer to a channel at a different transmission time that is distinct from a transmission time of the first NTN link 1051.

In addition, the first base station 1001 and the second base station 1002 may be connected through an Xn interface 1061 used in a backhaul network between the base stations. The Xn interface 1061 may support control plane functions such as secondary node addition, reconfiguration, modification, and release as dual connectivity functions, and support data forwarding and flow control functions as user plane functions.

The first gateway 1031 and the first base station 1001 may be connected by wire or wirelessly as previously described in FIGS. 8A and 8B, and may be installed at the same location as the first base station 1001 in a specific case. The second gateway 1032 and the second base station 1002 may also be connected by wire or wirelessly, and may be installed at the same location as the first base station 1001 in a specific case.

As described above, the first NTN link 1051 may include a service link between the terminal 1010 and the first satellite 1041 and a feeder link between the first satellite 1041 and the first gateway 1031. In addition, the second NTN link 1052 may include a service link between the terminal 1010 and the second satellite 1042 and a feeder link between the second satellite 1042 and the second gateway 1032. In FIG. 10A, the first satellite 1041 may be an LEO satellite, and the second satellite 1042 may be a GEO satellite. Alternatively, the second satellite 1042 may be a high elliptical orbit (HEO) satellite. In other words, it should be noted that this is intended to describe a case where there is a significant altitude difference between the first satellite 1043 and the second satellite 1044 illustrated in FIG. 10A.

Based on the above description, comparing latencies of the first NTN link 1061 and the second NTN link 1062, the latency of the second NTN link 1062 is always longer. This is because GEO satellites are located at a very high altitude compared to LEO satellites. In other words, this is because a delay of the service link between the terminal 1010 and the second satellite 1042 constituting the second NTN link 1052 is much longer than a delay of the service link between the terminal 1010 and the first satellite 1041, and a delay of the feeder link between the second satellite 1042 and the second gateway 1032 is much longer than a delay of the feeder link between the first satellite 1041 and the first gateway 1031.

The third NTN link 1053 according to the present disclosure may be a sub-link for transmitting an HARQ feedback for data transmitted through the second NTN link 1052. In other words, since the second NTN link 1052 has a long latency, for fast feedback, the third NTN link 1053, which has a short latency, may be used for HARQ feedback transmission and/or data retransmission.

In order to transmit, through the third NTN link 1053, an HARQ feedback and/or retransmission data corresponding to data transmitted between the terminal 1010 and the second base station 1002, the second base station 1002 may need to provide the first base station 1001 with HARQ feedback-related information transmitted to the terminal 1010 and information related to the data transmitted to the terminal 1010. Such information may be transmitted between the first base station 1001 and the second base station 1002 through the Xn interface 1061 described above.

In addition, in order to transmit, through the third NTN link 1053, the HARQ feedback and/or retransmission data corresponding to the data transmitted through the second NTN link 1052, the first base station 1001 may need to establish the third NTN link 1053 with the terminal 1010 via the first satellite 1041. Operations related to this will be described in more detail with reference to the drawings described later.

Meanwhile, as described in the previous drawings, the first NTN link 1051 is indicated with a solid line and the second NTN link 1052 is indicated with a dotted line in FIG. 10A. This is to distinguish the respective links connected via different satellites. In addition, in FIG. 10A, the third NTN link 1053 operating as a sub-link is illustrated with a dotted line. The third NTN link 1053 according to the present disclosure may be a sub-link for transmitting the HARQ feedback and/or retransmission data for the second NTN link 1052. Therefore, it should be noted that in order to identify that it is a link related to the second NTN link 1052, the third NTN link is indicated with a dotted line, similarly to the second NTN link.

FIG. 10B is a conceptual diagram illustrating configuration of an HARQ feedback link when one terminal is connected to satellites at different altitudes operating as multiple TRPs according to a second exemplary embodiment of the present disclosure.

As shown in FIG. 10B, a first NTN link 1071 may be composed of the terminal 1010, a first satellite 1043, a gateway 1033, and a base station 1003, and a second NTN link 1072 may be comprised of the terminal 1010, a second satellite 1044, the gateway 1033, and the base station 1003. A third NTN link 1073 may be configured with the same path as the first NTN link 1071. However, the third NTN link 1073 may be used as a path for HARQ feedback transmission and/or data retransmission according to the present disclosure. The third NTN link 1073 according to the present disclosure may be configured as a separate channel from the first NTN link 1071, or may be implemented as a portion of the first NTN link 1071. In the present disclosure, the ‘separate channel’ may refer to a channel at a different transmission time that is distinct from a transmission time of the first NTN link 1071.

In FIG. 10B, since the different satellites 1043 and 1044 are connected to one gateway 1033 and one base station 1003, it should be noted that the Xn interfaces with other base stations (e.g. base stations that do not have NTN links connected to the terminal 1010 via satellites) are not illustrated.

The gateway 1033 and the base station 1003 may be connected by wire or wirelessly as previously described in FIGS. 8A and 8B, and may be installed at the same location as the base station 1003 in a specific case.

As described above, the first NTN link 1071 may include a service link between the terminal 1010 and the first satellite 1043 and a feeder link between the first satellite 1043 and the gateway 1033. In addition, the second NTN link 1072 may include a service link between the terminal 1010 and the second satellite 1044 and a feeder link between the second satellite 1044 and the gateway 1033. In FIG. 10B, similarly to FIG. 10A described above, the first satellite 1043 may be an LEO satellite, and the second satellite 1044 may be a GEO satellite. Alternatively, the second satellite 1044 may be an HEO satellite. In other words, it should be noted that this is intended to describe a case where there is a significant altitude difference between the first satellite 1043 and the second satellite 1044.

Based on the above description, comparing latencies of the first NTN link 1071 and the second NTN link 1072, the latency of the second NTN link 1072 is always longer. This is because GEO satellites are located at a very high altitude compared to LEO satellites. In other words, this is because a delay of the service link between the terminal 1010 and the second satellite 1044 constituting the second NTN link 1072 is much longer than a delay of the service link between the terminal 1010 and the first satellite 1043, and a delay of the feeder link between the second satellite 1044 and the gateway 1033 is much longer than a delay of the feeder link between the first satellite 1043 and the gateway 1033.

In FIG. 10B, as previously described in FIG. 9E, the terminal 1010 may be connected to different satellites 1043 and 1044, respectively, and the satellites 1043 and 1044 may be connected to one base station 1003 via one gateway 1033. Accordingly, each of the different satellites 1043 and 1044 may operate as a TRP. Therefore, the configuration of FIG. 10B may correspond to a case where the LEO satellite and the GEO satellite operate as multiple TRPs for one terminal.

The third NTN link 1073 according to the present disclosure may be a sub-link for transmitting an HARQ feedback and/or retransmission data for data transmitted through the second NTN link 1072. In other words, since the second NTN link 1072 has along latency, the third NTN link 1073 having a short latency may be used when fast HARQ feedback and/or fast data retransmission is required.

In addition, in order to transmit, through the third NTN link 1073, the HARQ feedback and/or retransmission data corresponding to the data transmitted through the second NTN link 1072, the base station 1003 may need to establish the third NTN link 1073 with the terminal 1010 via the first satellite 1043. Operations related to this will be described in more detail with reference to the drawings described later.

Meanwhile, as described in the previous drawings, in FIG. 10B, the first NTN link 1071 is indicated with a solid line, and the second NTN link 1072 is indicated with a dotted line. This is to distinguish the respective links. In addition, the third NTN link 1073 is illustrated with a dotted line. Since the third NTN link 1073 according to the present disclosure is a sub-link for transmitting the HARQ feedback and/or retransmission data for the second NTN link 1072, it is indicated with the same dotted line as the second NTN link 1072.

The present disclosure will be described again with reference to FIGS. 10A and 10B described above. In the present disclosure, anew link that can reduce the latency of HARQ feedback or retransmission, for example, the third NTN links 1053 and 1073 described in FIGS. 10A and 10B, is defined. In the following description, each of the third NTN links 1053 and 1073 will be referred to as ‘sub-link’. Therefore, in a multi-connectivity and/or multi-TRP environment using the first NTN link and the second NTN link, the sub-link may be understood as a link newly established for HARQ feedback transmission and/or data retransmission for a link having a longer latency among the first NTN link and the second NTN link.

The present disclosure assumes that each link may have a sub-link in the multi-link environment. For example, the multi-connectivity or multi-TRP environment as shown in FIGS. 10A and 10B may be assumed. In FIG. 10A, the UE 1010 may be in a state of multi-connectivity with two different base stations 1001 and 1002 through the NTN links 1051 and 1052. Similarly, in FIG. 10B, the UE 1010 may be connected to one base station 1003 via two satellites 1043 and 1044 through the NTN links 1071 and 1072. Both the case of FIG. 10A and the case of FIG. 10B may have a sub-link. In FIG. 10A, the sub-link 1053 is indicated with a dotted line, and the sub-link 1053 may be a sub-link corresponding to the second NTN link 1052. Since the first NTN link 1051 does not require an additional sub-link, a sub-link for it is not illustrated.

Hereinafter, the sub-link will be described. In particular, when transmitting an HARQ feedback through the sub-link in the multi-connectivity situation as shown in FIG. 10A, an HARQ feedback received by the first base station 1002 may be delivered to the second base station 1002 through the Xn interface 1061. In the case of multi-TRP environment as shown in FIG. 10B, when an HARQ feedback is transmitted through the sub-link, it may be immediately received by the common base station 1003 of the satellites 1043 and 1044.

### [Feedback Through a Sub-Link in Multi-Connectivity Environment for NTN]

FIG. 11A is a signal flow diagram for a case of transmitting an HARQ feedback when one terminal is in a state of multi-connectivity via satellites at different altitudes according to a first exemplary embodiment of the present disclosure.

The signal flow illustrated in FIG. 11A will be described based on the configuration corresponding to the case where one terminal is in a state of multi-connectivity via satellites at different altitudes, which is described in FIG. 10A. Therefore, FIG. 11A is a signal flow diagram for a case where the base stations 1001 and 1002 are connected to the UE, which is the terminal 1010, through the first NTN link 1051 and the second NTN link 1052 via the satellites 1041 and 1042 at different altitudes, respectively. In addition, FIG. 11A represents the signal flow when a sub-link is not used.

Before describing the example of FIG. 11A, it should be noted that the first base station 1001 and the second base station 1002 are assumed to know in advance that the first NTN link 1051 and the second NTN link 1052 have been established with the terminal 1010. The first base station 1001 or the second base station 1002 may know that an NTN link has been established between the other base station (i.e. the second base station 1002 or the first base station 1001) and the terminal 1010, based on information received from an upper node of the core network, such as AMF and/or UPF.

When each of the first base station 1001 and the second base station 1002 knows that an NTN link via the other base station exists, it may identify information on a propagation delay for each of the NTN links 1051 and 1052 through signaling with the other base station and/or based on information provided from the core network. Since at least one of the satellites respectively corresponding to the NTN links 1051 and 1052 is a moving satellite, in order for each base station to obtain accurate information on the propagation delays, information on the propagation delays may be obtained through signaling between the base stations. The base stations 1001 and 1002 may know which NTN link has a shorter latency based on the propagation delays. Accordingly, the base stations 1001 and 1002 may know in advance which base station needs to establish a sub-link according to the present disclosure, that is, the third NTN link 1053.

In the present disclosure described below, it is assumed that each of the base stations 1001 and 1002 knows in advance which base station needs to establish the third NTN link 1053, and that the third NTN link 1053 has already been established. Here, the state where the third NTN link 1053 has been established may mean a state where a corresponding resource has been reserved or a state that the third NTN link 1053 can be used, when the third link 1053 uses a portion of the first NTN 1051. As another example, the state where the third NTN link 1053 has been established may mean a state where a procedure of establishing the third link 1053 has been completed with the terminal 1010, when the third NTN link 1053 uses a temporally and/or physically different channel from the first NTN link 1051.

In addition, in order to obtain information on the propagation delays at the base stations 1001 and 1002, it may be assumed that information on the propagation delays or information capable of calculating the propagation delays is being exchanged (or transmitted) at a preset periodicity. The operation for obtaining information on the propagation delays at the base stations 1001 and 1002 may be performed based on triggering by at least one base station or may be performed periodically while the terminal 1010 is connected to two satellites.

In step S1100, the first base station 1001 and the second base station 1002 may perform a physical uplink control channel (PUCCH) resource allocation procedure for a sub-link for a specific NTN link among the connected NTN links. Referring to FIG. 10A, the second base station 1002 may transmit a PUCCH resource allocation request signal (or, message) for HARQ feedback reception through the third NTN link 1053, which is a sub-link for the second NTN link 1052 established with the terminal 1010.

The first base station 1001, which has received the signal (or message) requesting PUCCH resource allocation for HARQ feedback transmission to the terminal 1010 from the second base station 1002, may determine whether to allocate a PUCCH resource on the third NTN link. For example, the first base station 1001 may determine whether to accept allocation of a PUCCH resource for HARQ feedback transmission through the sub-link (i.e. the third NTN link 1053) in consideration of whether a resource allocatable as a PUCCH resource exists, a congestion level of the first NTN link, a congestion level of the Xn interface 1061, and a load of the first base station 1001. In addition, the first base station 1001 may generate a response signal indicating whether to accept allocation of the PUCCH resource for HARQ feedback transmission to the third NTN link 1053 and transmit it to the second base station 1002. In this case, when the response signal (or response message) indicates acceptance, the response signal may include information on the PUCCH resource for receiving an HARQ feedback through the third NTN link 1053, such as frequency resource information, time resource information, and HARQ transmission timing information.

Additionally, in step S1100, the first base station 1001 and the second base station 1002 may transmit and receive information necessary for feedback transmission on the sub-link. For example, in order to compensate for a difference between the propagation delay of the second NTN link 1052 and the propagation delay of the sub-link 1053, the second base station 1002 may need to provide its timing related information to the first base station 1001 having the sub-link. Based on this information, the first base station 1001 having the sub-link may know at what time point the terminal 1010 is to transmit the feedback. In addition, the first base station 1001 having the sub-link 1053 may inform the second base station 1002 of information on whether the use of the sub-link is accepted, a BWP to receive the feedback, frequency resource, time resource, etc. and information on up to which time point this information will be used (or whether it can be used).

In step S1110, the second base station 1002 may decide not to use the sub-link 1053 if the response received in S1100 indicates that allocation of a PUCCH resource for HARQ feedback transmission is rejected. On the other hand, if the response received in S1100 indicates that allocation of a PUCCH resource for HARQ feedback transmission is accepted, the second base station 1002 may decide to use the sub-link 1053 based on various situations. For example, the second base station 1002 may decide whether to use the sub-link in consideration of a QoS requirement of the transmitted data, characteristics of the data, information on a link latency between the second base station 1002 and the terminal 1010, and/or the like.

Here, as the QoS requirement of the data, a data transmission rate, allowable retransmission latency, minimum data transmission rate, maximum data transmission rate, and/or the like may be considered. In addition, as the characteristics of the data, whether the data is voice data and/or real-time streaming data may be considered.

Considering the various factors described above, the second base station 1002 may decide not to use the sub-link. If the second base station 1002 decides not to use the sub-link, it may configure a PDSCH scheduling DCI. In other words, the second base station 1002 may configure the PDSCH scheduling DCI by including an indicator indicating that the sub-link is not used, and allocation information of a PUCCH for HARQ feedback transmission on the second NTN link 1052.

Based on the above decision, the second base station 1002 may transmit the PDSCH scheduling DCI determined as above to the terminal 1010 via the second satellite 1042 in step S1110.

In step S1112, the second base station 1002 may inform the first base station 1001 that the HARQ feedback is to be transmitted through the second NTN link based on the above decision. If the decision of the second base station 1002 is made in advance and notified to the first base station 1001 in step S1100, or if the first base station 1001 does not accept the sub-link 1053, step S1112 may be omitted.

Additionally, when the second base station 1002 performs both steps S1110 and S1112, an order thereof may be changed differently from that illustrated in FIG. 11A. In other words, the second base station 1002 may perform step S1112 first and then step S1110.

In step S1114, the second base station 1002 may transmit downlink data to the terminal 1010 on a PDSCH through the second NTN link 1052. The terminal 1010 may receive the data transmitted in step S1114 based on the DCI previously received in step S1110. The terminal 1010 may demodulate and decode the received data in step S1114.

In step S1116, the terminal 1010 may transmit a decoding result to the second base station 1002 through the PUCCH of the second NTN link 1052 determined based on the DCI received in step S1110.

In the example of FIG. 11A described above, the case where the second base station 1002 does not use the sub-link has been described. The case where the second base station 1002 decides to use the sub-link will be described with reference to FIG. 11B.

FIG. 11B is a signal flow diagram for another case of transmitting an HARQ feedback when one terminal is in a state of multi-connectivity via satellites at different altitudes according to the first exemplary embodiment of the present disclosure.

The signal flow illustrated in FIG. 11B will be described based on the configuration corresponding to the case where one terminal is in a state of multi-connectivity via satellites at different altitudes, which is described in FIG. 11A. Therefore, FIG. 11B is a signal flow diagram for the case where the base stations 1001 and 1002 are connected to the UE, which is the terminal 1010, through the first NTN link 1051 and the second NTN link 1052 via the satellites 1041 and 1042 at different altitudes, respectively. In addition, FIG. 11B shows the signal flow when the sub-link is used.

The contents described in FIG. 11A may also be applied to the example of FIG. 11B. For example, it is assumed that the first base station 1001 and the second base station 1002 know in advance that the first NTN link 1051 and the second NTN link 1052 have been established with the terminal 1010. The first base station 1001 or the second base station 1002 may know that the other base station has established the NTN link with the terminal 1010 based on information received from an upper node of the core network, for example, AMF and/or UPF.

When each of the first base station 1001 and the second base station 1002 knows that the NTN link has been established through the other base station, it may identify information on a propagation delay for each of the NTN links 1051 and 1052 through signaling with the other base station and/or based on information provided from the core network. Since at least one of the satellites respectively corresponding to the NTN links 1051 and 1052 is a moving satellite, in order for each base station to obtain accurate information on the propagation delays, information on the propagation delays may be obtained through signaling between the base stations. The base stations 1001 and 1002 may know which NTN link is a link having a shorter latency based on information on the propagation delays. Accordingly, the base stations 1001 and 1002 may know in advance which base station needs to establish the sub-link according to the present disclosure, that is, the third NTN link 1053.

In the present disclosure described below, it is assumed that each of the base stations 1001 and 1002 knows in advance which base station needs to establish the third NTN link 1053, and that the third NTN link 1053 has already been established. Here, the state where the third NTN link 1053 has been established may mean a state where a corresponding resource has been reserved or a state that the third NTN link 1053 can be used, when the third link 1053 uses a portion of the first NTN 1051. As another example, the state where the third NTN link 1053 has been established may mean a state where a procedure of establishing the third link 1053 has been completed with the terminal 1010, when the third NTN link 1053 uses a temporally and/or physically different channel from the first NTN link 1051.

In addition, in order to obtain information on the propagation delays at the base stations 1001 and 1002, it may be assumed that information on the propagation delays or information capable of calculating the propagation delays is being exchanged (or transmitted) at a preset periodicity. The operation for obtaining information on the propagation delays at the base stations 1001 and 1002 may be performed based on triggering by at least one base station or may be performed periodically while the terminal 1010 is connected to two satellites.

Step S1100 may be the same procedure as the operation previously described in FIG. 11A. In other words, the first base station 1001 and the second base station 1002 may perform a physical uplink control channel (PUCCH) resource allocation procedure for a sub-link for a specific NTN link among the connected NTN links. Referring to FIG. 10A, the first base station 1001 having the sub-link 1053 may provide information on whether the use of the sub-link is approved, a BWP to receive the feedback, frequency resource, time resource, etc. and information on up to which time point this information will be used (or whether it can be used).

In step S1120, the second base station 1002 may decide not to use the sub-link 1053 if the response received in S1100 indicates that allocation of a PUCCH resource for HARQ feedback transmission is rejected. On the other hand, if the response received in S1100 indicates that allocation of a PUCCH resource for HARQ feedback transmission is accepted, the second base station 1002 may decide to use the sub-link 1053 based on various situations. For example, the second base station 1002 may decide whether to use the sub-link in consideration of a QoS requirement of the transmitted data, characteristics of the data, information on a link latency between the second base station 1002 and the terminal 1010, and/or the like. Here, as the QoS requirement of the data, a data transmission rate, allowable retransmission latency, minimum data transmission rate, maximum data transmission rate, and/or the like may be considered. In addition, as the characteristics of the data, whether the data is voice data and/or real-time streaming data may be considered.

Considering the various factors described above, the second base station 1002 may decide to use the sub-link. If the second base station 1002 decides to use the sub-link, it may configure a PDSCH scheduling DCI. In other words, the second base station 1002 may configure the PDSCH scheduling DCI by including an indicator indicating that the sub-link is used, and allocation information of a PUCCH for HARQ feedback transmission on the third NTN link 1053 (i.e. sub-link). In addition, the DCI, as allocation information of a PUCCH on the third NTN link 1053, which is the sub-link for HARQ feedback transmission, may also include information on a transmission timing (hereinafter referred to as ‘K1’) of the PUCCH of the sub-link and frequency resource allocation information. Here, there may be various methods for delivering the value of K1 and PUCCH frequency allocation information, and three cases will be described as examples below.

First, there may be a method of defining and utilize a new DCI Format that includes information related to the sub-link (e.g. K1, PUCCH allocation information, etc.).

Second, there may be a method of adding a new field to a DCI Format1_0/Format1_1 for PDSCH scheduling, which is defined and used in the current 5G standard. The newly added field may be an indicator indicating to use the sub-link and/or information related to the feedback through the sub-link, such as K1 and PUCCH allocation information.

Third, the DCI Format1_0/Format1_1 used for PDSCH scheduling, which is currently defined and used in the 5G standard, may be used as is, and a field such as PDSCH-to-HARQ_feedback timing indicator and PUCCH resource indicator, which is designated by an RRC message, may be used to deliver the value of K1 and PUCCH allocation information. In this case as well, a new indicator indicating to use the sub-link may be added.

Based on the above decision, the second base station 1002 may transmit the DCI for PDSCH scheduling determined as above to the terminal 1010 through the second satellite 1042 in step S1120.

The K1 value described above is a value indicating the number of slots corresponding to a delay offset, which is configured for transmitting an HARQ feedback ACK or NACK in response to the PDSCH through the PUCCH. That is, it is a value indicating a delayed slot for uplink control information (UCI) transmitted from the terminal 1010 to the base station.

In step S1122, the second base station 1002 may inform the first base station 1001 that the HARQ feedback is transmitted through the third NTN link 1053, which is the sub-link, based on the above decision. In this case, the resource allocation information transmitted from the second base station 1002 to the terminal 1010 may also be notified to the first base station 1001. The case where the second base station 1002 informs the first base station 1001 of the resource allocation information transmitted to the terminal 1010 may correspond to a case where the resource allocation information transmitted to the terminal 1010 is different from resource allocation information negotiated with the first base station 1001.

Through step S1122, the first base station 1002 may know that the terminal 1010 is scheduled to transmit the feedback for the second base station 1002 through the sub-link 1053. If it has been agreed in advance to use the sub-link 1053 in step S1110, step S1122 may be omitted.

As described in FIG. 11A, when the second base station 1002 performs both steps S1110 and S1112, the order thereof may be changed differently from that illustrated in FIG. 11A. In other words, the second base station 1002 may perform step S1112 first and then step S1110.

In step S1124, the second base station 1002 may transmit downlink data to the terminal 1010 through the second NTN link 1052 on the PDSCH. The terminal 1010 may receive the data transmitted in step S1124 based on the DCI previously received in step S1120. The terminal 1010 may demodulate and decode the received data in step S1124.

In step S1126, the terminal 1010 may transmit a decoding result to the first base station 1001 on the PUCCH through the third NTN link 1053, which is the sub-link determined based on the DCI received in step S1120. In the present disclosure, the description is made assuming that the decoding result is transmitted on the PUCCH. However, in some cases, the decoding result may be transmitted on a physical uplink shared channel (PUSCH). It should be noted that in the present disclosure, for convenience of description, it is assumed that the decoding result is transmitted on the PUCCH. Therefore, in all exemplary embodiments described below, although only the case where the decoding result is transmitted on the PUCCH is described, the case where the decoding result is transmitted on the PUSCH may be also possible.

In step S1128, the first base station 1001 may deliver HARQ feedback information for the PDSCH transmitted through the second NTN link, which is received from the terminal 1010, to the second base station 1002 through the Xn interface 1061.

The contents commonly applied to FIGS. 11A and 11B described above will be described. Step S1100 in FIGS. 11A and 11B described above may be configured not to be performed every time data is transmitted to the terminal 1010. For example, step S1100 may be configured to be performed at a preset periodicity, based on triggering by the second base station 1002 requiring the sub-link when data transmission is necessary, or only when a state of the first base station 1001 receiving the PUCCH through the sub-link is changed.

In addition, a method of informing whether or not the sub-link is used, which is included in the DCI, may be performed by a toggling scheme. When whether to use the sub-link is notified by using the toggling scheme, the indicator notifying the use of the sub-link may not be included every time PDSCH scheduling occurs in step S1110 or step S1120.

In the signal flow diagram of FIG. 11B, the first base station 1001 having the sub-link may need to distinguish an HARQ feedback for data the first base station 1001 transmits to the terminal 1010 through the first NTN link, and an HARQ feedback for data the second base station 1002 transmits to the terminal 1010 through the second NTN link. Therefore, a method may be used in which the first base station 1001 and the second base station 1002 share information on HARQ process numbers used by each other. For example, based on prior signaling between the first base station 1001 and the second base station 1002, the second base station 1002 may use HARQ process numbers from 0 to 21, and the first base station 1001 may use HARQ process numbers 22 to 31. This is merely one example, and when the HARQ process numbers from 0 to 31 are available for the first base station 1001 and the second base station 1002, a range of HARQ process numbers used by each base station may be appropriately determined.

As another method, in step S1100 of FIG. 11B where the first base station 1001 determines the PUCCH resource (time/frequency resource) of the sub-link for the data of the second base station 1002, it is possible to distinguish between the two HARQ feedbacks by restricting the PUCCH resource for the data transmitted by the second base station 1002 from being separated from the PUCCH resource for the data transmitted by the first base station 1001.

In FIGS. 11A and 11B described above, the method in which a link with a large propagation delay configures a link with a relatively small propagation delay as a sub-link when one terminal is connected to satellite at different altitudes has been described.

### [Feedback Through a Sub-Link in Multi-TRP Environment for NTN]

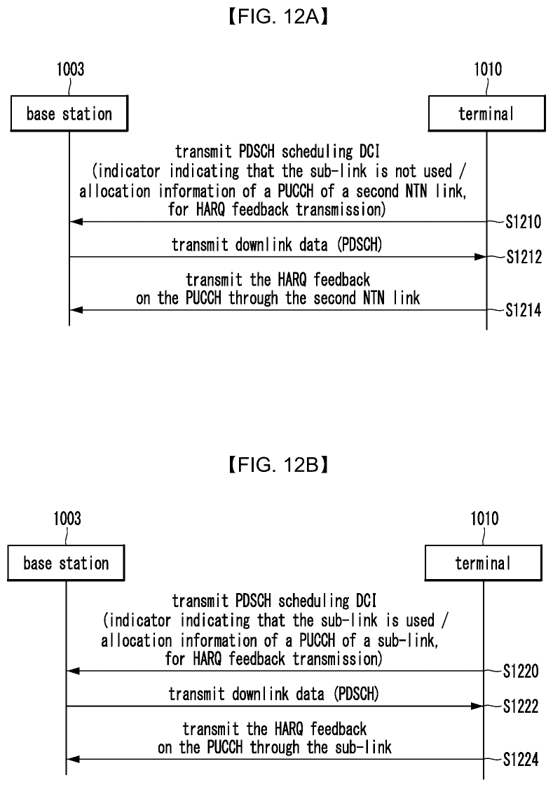

FIG. 12A is a signal flow diagram for a case of transmitting an HARQ feedback when one terminal is connected to satellites at different altitudes operating as multiple TRPs according to a second exemplary embodiment of the present disclosure.

The signal flow illustrated in FIG. 12A will be described based on the configuration corresponding to the case where one terminal is connected to satellites at different altitudes operating as multiple TRPs, which is described above in FIG. 10B. Therefore, FIG. 12A is a signal flow diagram for the case where the base station 1003 is connected to the terminal 1010 through the first NTN link 1071 and the second NTN link 1072 via the satellites 1043 ad 1044 at different altitudes, respectively. In addition, FIG. 12A shows the signal flow when using the sub-link is not used.

Before describing the example of FIG. 12A, it should be noted that the base station 1003 knows in advance that the first NTN link 1071 and the second NTN link 1072 have been established for the terminal 1010. In addition, since both data of the first NTN link and data of the second NTN link are processed by the base station 1003, the base station 1003 already knows a latency of each of the NTN links 1071 and 1072. In other words, the base station 1003 may know that the first NTN link in FIG. 10B has a shorter latency and the second NTN link has a longer latency. Therefore, the base station 1003 may also know through which satellite the third NTN link 1073, which is a sub-link according to the present disclosure, needs to be established.

Before describing FIG. 12A, it should be noted that the base station 1003 may have established the third NTN link 1073, which is a sub-link, via the first satellite 1043. Here, the state where the third NTN link 1073 has been established may mean a state where a corresponding resource has been reserved or a state that the third NTN link 1073 can be used, when the third link 1073 uses a portion of the first NTN 1071. As another example, the state where the third NTN link 1073 has been established may mean a state where a procedure of establishing the third link 1073 has been completed with the terminal 1010, when the third NTN link 1073 uses a temporally and/or physically different channel from the first NTN link 1071.

In step S1210, the base station 1003 may decide to use the sub-link 1073 based on various situations. For example, the base station 1003 may decide whether to use the sub-link in consideration of a QoS requirement of the transmitted data, characteristics of the data, information on a link latency between the second NTN link 1072 and the terminal 1010, and/or the like. Here, as the QoS requirement of the data, a data transmission rate, allowable retransmission latency, minimum data transmission rate, maximum data transmission rate, and/or the like may be considered. In addition, as the characteristics of the data, whether the data is voice data and/or real-time streaming data may be considered.

Considering the various factors described above, the base station 1003 may decide not to use the sub-link. If the base station 1003 decides not to use the sub-link, it may configure a PDSCH scheduling DCI. In other words, the second base station 1002 may configure the PDSCH scheduling DCI by including an indicator indicating that the sub-link is not used, and allocation information of a PUCCH for HARQ feedback transmission on the second NTN link 1072. Then, the base station 1003 may transmit the PDSCH scheduling DCI configured in step S1210 to the terminal 1010 through the second NTN link via the second satellite 1044.

In step S1212, the base station 1003 may transmit downlink data to the terminal 1010 through the second NTN link 1052 based on the above decision.

In addition, the terminal 1010 may receive the data transmitted through the second NTN link 1072 via the second satellite 1044 in step S1212 based on the DCI previously received in step S1210. The terminal 1010 may demodulate and decode the received data in step S1212.

In step S1214, the terminal 1010 may transmit a decoding result to the base station 1003 through the PUCCH of the second NTN link 1052 determined based on the DCI received in step S1210.

FIG. 12B is a signal flow diagram for a case of transmitting an HARQ feedback when one terminal is connected to satellites at different altitudes operating as multiple TRPs according to the second exemplary embodiment of the present disclosure.

The signal flow illustrated in FIG. 12B will be described based on the configuration corresponding to the case where one terminal is connected to satellites at different altitudes operating as multiple TRPs, which is described above in FIG. 10B. Therefore, FIG. 12B is a signal flow diagram for the case where the base station 1003 is connected to the terminal 1010 through the first NTN link 1071 and the second NTN link 1072 via the satellites 1043 ad 1044 at different altitudes, respectively. In addition, FIG. 12B shows the signal flow when using the sub-link is used.

The assumptions described in FIG. 12A may also be used in FIG. 12B. In other words, the base station 1003 knows in advance that the first NTN link 1071 and the second NTN link 1072 have been established for the terminal 1010. In addition, since both data of the first NTN link and data of the second NTN link are processed by the base station 1003, the base station 1003 already knows a latency of each of the NTN links 1071 and 1072. Therefore, the base station 1003 may also know through which satellite the third NTN link 1073, which is a sub-link according to the present disclosure, needs to be established.

Additionally, the base station 1003 may have established the third NTN link 1073, which is a sub-link, via the first satellite 1043. Here, the state where the third NTN link 1073 has been established may mean a state where a corresponding resource has been reserved or a state that the third NTN link 1073 can be used, when the third link 1073 uses a portion of the first NTN 1071. As another example, the state where the third NTN link 1073 has been established may mean a state where a procedure of establishing the third NTN link 1073 has been completed with the terminal 1010, when the third NTN link 1073 uses a temporally and/or physically different channel from the first NTN link 1071.

In step S1220, the base station 1003 may decide to use the sub-link 1073 based on various situations. For example, the base station 1003 may decide whether to use the sub-link in consideration of a QoS requirement of the transmitted data, characteristics of the data, information on a link latency between the second NTN link 1072 and the terminal 1010, and/or the like. Here, as the QoS requirement of the data, a data transmission rate, allowable retransmission latency, minimum data transmission rate, maximum data transmission rate, and/or the like may be considered. In addition, as the characteristics of the data, whether the data is voice data and/or real-time streaming data may be considered.

Considering the various factors described above, the base station 1003 may decide to use the sub-link. If the base station 1003 decides to use the sub-link, it may configure a PDSCH scheduling DCI. In other words, the second base station 1002 may configure the PDSCH scheduling DCI by including an indicator indicating that the sub-link is used, and allocation information of a PUCCH on the third NTN link 1073, which is the sub-link for HARQ feedback transmission. Then, the base station 1003 may transmit the PDSCH scheduling DCI configured in step S1220 to the terminal 1010 through the second NTN link via the second satellite 1044.

In step S1222, the base station 1003 may transmit downlink data to the terminal 1010 on a PDSCH through the second NTN link 1052 based on the above decision.

In addition, the terminal 1010 may receive the data transmitted through the second NTN link 1072 via the second satellite 1044 in step S1222 based on the DCI previously received in step S1220. The terminal 1010 may demodulate and decode the received data in step S1222.

In step S1224, the terminal 1010 may transmit a decoding result to the base station 1003 on the PUCCH through the third NTN link 1053 determined based on the DCI received in step S1220.

The operations of FIGS. 12A and 12B described above may be subject to the contents previously described and commonly applied to FIGS. 11A and 11B. For example, a method of informing whether or not the sub-link is used, which is included in the DCI, may be performed by a toggling scheme. In addition, the base station 1003 may apply a method for distinguishing between an HARQ feedback for data transmitted to the terminal 1010 through the first NTN link 1071 and an HARQ feedback for data transmitted to the terminal 1010 through the second NTN link 1072. In other words, a method of distinguishing HARQ process numbers may be applied.

### [HARQ Feedback Timing Considering a Difference in Timing Due to Propagation Delays]

In the present disclosure described below, an HARQ feedback timing considering a timing difference due to propagation delays when a sub-link is used as in the signal flow of FIG. 11B in the multi-connectivity environment such as that of FIG. 10A described above will be described.

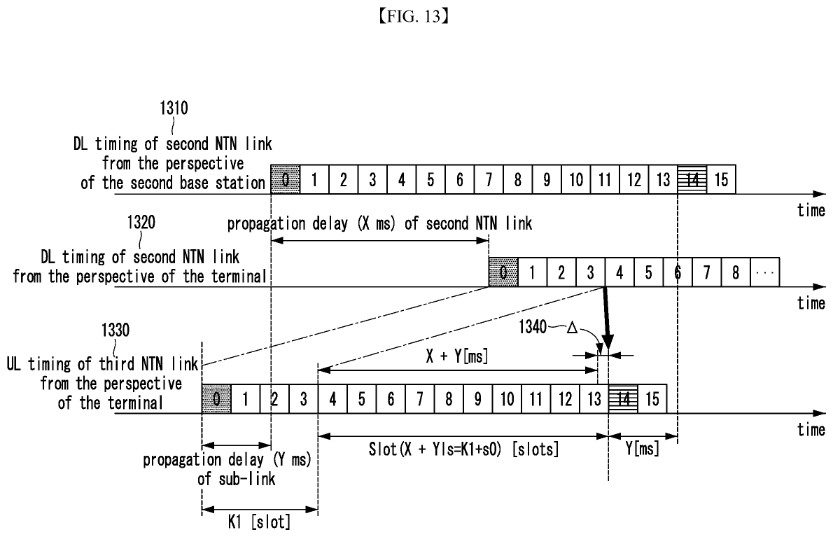

FIG. 13 is a timing diagram of an NTN link through which data is transmitted and a sub-link corresponding thereto in a multi-connectivity environment according to an exemplary embodiment of the present disclosure.

Since the timing diagram of FIG. 13 shows a signal timing in the multi-connectivity environment described in FIG. 10A, it will be described with reference to the configuration of FIG. 10A. First, to simplify the problem, it is assumed that downlink (DL) and uplink (UL) respectively have the same transmit/reception timings on the second NTN link 1052, which is a link through which data is transmitted to the terminal 1010, and the third NTN link 1053, which is a sub-link through which an HARQ feedback is transmitted. In addition, it is assumed that a timing error between the second NTN link 1052 and the third NTN link 1053 is at a minor level. In addition, it is assumed that this error can be compensated for through some additional correction after determining timings according to the present disclosure described below.

A DL timing 1310 of the second NTN link from the perspective of the second base station is illustrated at the top of FIG. 13. From the perspective of the second base station, a propagation delay on the second NTN link 1052 when transmitting a PDSCH to the terminal 1010 in a slot 0 according to the DL timing 1310 of the second NTN link may be X milliseconds (ms). Then, from the perspective of the terminal, the terminal may receive DL data transmitted by the second base station 1002 in a slot 0 after X ms, similarly to the DL timing 1320 of the second NTN link. In this case, the DL data may be transmitted on the PDSCH.

Then, the terminal 1010 may decode the PDSCH received in the slot 0. The terminal 1010 may generate a response signal, such as ACK/NACK, based on a decoding result for the PDSCH received in the slot 0. The terminal 1010 may determine an HARQ feedback timing based on K1 indicated by the DCI. Therefore, the terminal 1010 may transmit an HARQ feedback after K1 slots. Here, since it is assumed that the terminal 1010 transmits the feedback through the third NTN link 1053 (i.e. sub-link), the feedback needs to be transmitted in accordance with an UL transmission timing of the sub-link.

In addition, since the third NTN link 1053 (i.e. sub-link) has a path composed of the first satellite 1041, the first gateway 1031, and the first base station 1001, the first base station 1001 may finally receive the HARQ feedback. Therefore, the value of K1 may be determined by the first base station 1001 managing the third NTN link 1053 (i.e. sub-link). On the other hand, since the first base station 1001 and the second base station 1002 exchange information with each other through the Xn interface, the second base station 1002 may determine the value of K1, and inform the determined value of K1 to the first base station 1001.

If an SCS of the third NTN link 1053 managed by the first base station 1001 is different from an SCS of the second NTN link 1052 managed by the second base station 1002, the value of K1 may be determined based on the SCS of the sub-link. If the SCS of the third NTN link 1053 and the SCS of the second NTN link 1052 are different from each other, and the second base station 1002 determines the value of K1 based on the SCS of the second NTN link 1052, the terminal 1010 may transmit the HARQ feedback according to the SCS of the third NTN link 1053 by scaling the value of K1 when transmitting the HARQ feedback through the third NTN link 1053.

Therefore, since the terminal 1010 needs to transmit the HARQ feedback in accordance with the transmission timing of the third NTN link 1053, the actual transmission timing may be determined as an UL timing 1330 of the third NTN link from the perspective of the terminal. Describing this further, a delay equal to the delay X [ms] of the second NTN link 1052 inevitably occurs. In addition, based on the first base station 1001 or the second base station 1002, the terminal 1010 may determine the value of K1 indicating a delayed slot of the UCI to be transmitted through the third NTN link 1053. Since the terminal 1010 needs to transmit the HARQ feedback according to the transmission timing of the third NTN link 1053, although the PDSCH in the slot 0 was actually transmitted through the second NTN link 1052, but the delay Y [ms] for a case when the PDSCH is assumed to be transmitted through the third link 1053 needs to be considered.

Therefore, considering these values as a whole, the UL timing 1330 of the third NTN link at the terminal may be determined as a slot 14, as illustrated in FIG. 13. In other words, the terminal 1010 may transmit, through the third NTN link 1053, the HARQ feedback for data received through the second NTN link 1052 in a slot 14 according to the UL timing 1330 of the third NTN link from the perspective of the terminal. Therefore, since the delay of Y [ms] is considered for the third NTN link 1053, the HARQ feedback may be received in a slot 14 based on the DL timing 1310 of the second NTN link from the perspective of the second base station.

Additionally, in order to receive the feedback at an appropriate timing, the second base station 1002 may need to calculate a slot for receiving the feedback in consideration of the latencies of the second NTN link 1052 and the third NTN link 1053 (i.e. sub-link). As can be seen in FIG. 13, the second base station 1002 may expect to receive the feedback signal for the data of the slot 0 when a time shown in Equation 1 below elapses.

$$HARQ feedback reception time = X + Y + Time ( n \vert s ) \qquad [ Equation 1 ]$$

In Equation 1 above, X and Y may be set in [ms] units as described above. In addition, in Equation 1, Time(n┐s) may mean the time length of n slots expressed in [ms] units when a slot s is a starting point, and may be a time value determined based on K1.

Therefore, the second base station 1002 may expect to receive the HARQ feedback after a time period calculated according to Equation 1. However, actual data transmission and reception are performed based on slots according to the SCS. Therefore, Equation 1 needs to be modified on a slot basis. If Equation 1 is modified on a slot basis, it may be expressed as Equation 2 below.

$$HARQ feedback reception slot = slot ( X + Y \vert s = 4 ) + K 1 \qquad [ Equation 2 ]$$

In Equation 2, when a number of the starting slot is s, slot(t|s) may be the minimum value of the number of slots that is greater than or equal to a time length of t. The reason ‘s=4’ is exemplified in Equation 2 of the present disclosure is because the value of ‘K1=4’, that is, an index of a reference slot is 4. Therefore, in Equation 2, s may be the slot index corresponding to K1. The reason for using the slot index of K1 like this is because the length of each slot may vary depending on the SCS in the NTN. For example, if the SCS is 15 KHz, all slots have the same length of 1 ms. On the other hand, if the SCS is 60 KHz or more, the length of the even-numbered slot and the length of the odd-numbered slot may different. Therefore, the reason for indicating the slot corresponding to K1 as ‘s=4’ in Equation 2 is to ensure that the SCS can be calculated based on Equation 2 no matter what value it has in the NTN.

Equation 2 may be expressed as a non-negative integer n that satisfies Equation 3 below.

$$Slot ( t \vert s ) = {arg}_{n} \{ Time ( n - 1 \vert s ) \} < t \leq Time ( n \vert s ) \} \qquad [ Equation 3 ]$$

If the movement of the satellite is additionally taken into account, a value of (X+Y) may change dynamically. Therefore, if Δ 1340 shown in FIG. 13 is a very small value, as (X+Y) changes, the slot where the feedback is transmitted may be changed to a slot 15. Therefore, the feedback slot may be selected by modifying Equation 3 so that Δ 1340 has a value greater than the minimum preset value Δ_{offset}, that is, as shown in Equation 4 below.

$$Slot ( t \vert s ) = {arg}_{n} \{ Time ( n - 1 \vert s ) \} < {Δ}_{offset} \leq Time ( n \vert s ) \} \qquad [ Equation 4 ]$$

### [Data Retransmission Using a Sub-Link]

Hereinafter, a signaling method for retransmitting NACKed data using a sub-link or a data transmission link, when the data transmission link through which the data is transmitted has the sub-link, in the multi-connectivity environment according to the present disclosure will be described.

Operations described below assume a situation in which a NACK is received as the HARQ feedback in FIG. 11A or 11B described above. In response to receiving the NACK, the base station may not perform retransmission, may perform retransmission through a data transmission link, or may perform retransmission through a sub-link. In the present disclosure, an operation method for performing retransmission through the sub-link will be described.

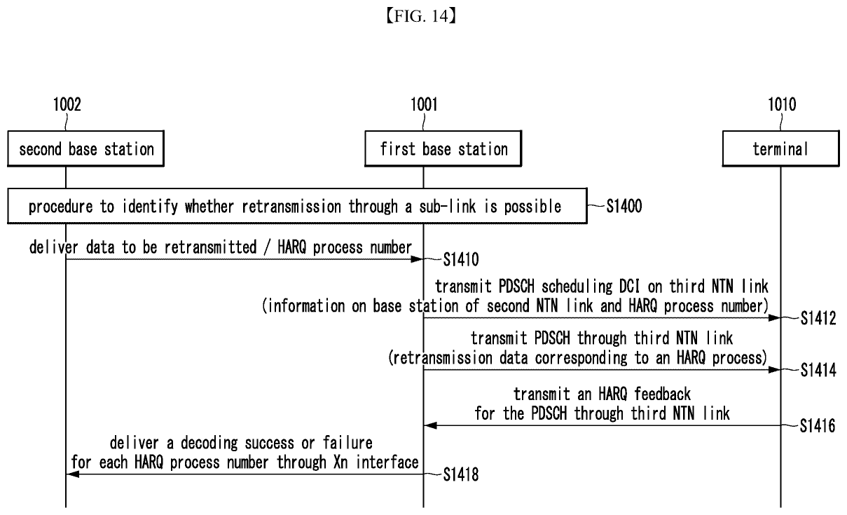

FIG. 14 is a signal flow diagram for data retransmission when one terminal is in a state of multi-connectivity via multiple satellites at different altitudes according to the present disclosure.

The signal flow illustrated in FIG. 14 will be described based on the configuration described in FIG. 10A, which corresponds to the case where one terminal is in a state of multi-connectivity with multiple satellites at different altitudes. Therefore, FIG. 14 is a signal flow diagram for a case where the base stations 1001 and 1002 are connected to the UE, which is the terminal 1010, through the first NTN link 1051 and the second NTN link 1052 via satellites 1041 and 1042 at different altitudes, respectively.

The signal flow of FIG. 14 may be for an operation occurring when the second base station 1002 receives a NACK as an HARQ feedback for data transmitted to the terminal 1010, as described above.

In step S1400, since the second base station 1002 that transmitted the data is in a state of having received a NACK in response to the transmitted data, the second base station 1002 may decide to perform data retransmission. Based on the decision to retransmit the data, the second base station 1002 may decide whether to retransmit the data through the second NTN link 1052 or the third NTN link 1053 (i.e. sub-link). When determining a link for data retransmission, the second base station 1002 may consider various factors such as a QoS required by the data, characteristics of the data, and a congestion level of the first base station 1001. In the present disclosure, the description will be made assuming that the second base station 1002 decides to retransmit the data through the third NTN link 1053 (i.e. sub-link).

When the second base station 1002 decides to retransmit the data through the sub-link, the second base station 1002 may transmit an inquiry message to the first base station 1001 to ask whether the data can be retransmitted through the third NTN link 1053 (i.e. sub-link). In this case, the second base station 1002 may transmit the inquiry message to the first base station 1001 through signaling using the Xn interface 1061. Here, the inquiry message may include information such as the number of TBs to be retransmitted (or amount of data) and a retransmission time.

The first base station 1001 receiving the inquiry message from the second base station 1002 may decide whether to accept retransmission by considering the information included in the inquiry message and a traffic through the first NTN link 1051, that is, a load to be transmitted. After the first base station 1001 decides whether to accept the retransmission, the first base station 1001 may transmit a response message including whether to accept the retransmission to the second base station 1002.

In the following description, it is assumed that the first base station 1001 accepts retransmission requested by the second base station 1002.

In step S1410, the second base station 1002 may receive the response message, and if retransmission is accepted by the received response message, may deliver the data to be retransmitted and an HARQ process number therefor to the first base station 1001 through the Xn interface 1061. In this case, the data to be retransmitted, which is delivered from the second base station 1002 to the first base station 1001, may be TB(s), data that is not coded in a physical layer, data coded in the physical layer, or coded data generated by the physical layer for retransmission. In all cases except the case where the data delivered from the second base station 1002 to the first base station 1001 is encoded data generated for retransmission, the second base station 1002 may additionally deliver codeword generation information for the physical layer to generate codeword(s) for retransmission. As the codeword generation information for generating the codeword(s) for retransmission, a code rate, encoding scheme, and data selection scheme during initial transmission and retransmission.

For example, if the second base station 1002 delivers PDSCH data before being encoded in step S1410, information used for LDPC encoding at the second base station 1002 in initial transmission needs to be delivered together. Based on such information, the first base station 1001 may use the same encoder as the second base station 1002. From the perspective of the terminal 1010, a combining gain may be obtained by combining the initially transmitted data and the data retransmitted based on the HARQ feedback.

In step S1412, the first base station 1001 may generate data to be retransmitted based on the data and the HARQ process number received from the second base station 1002. In this case, if the data received from the first base station 1001 is not the coded data generated for retransmission, the second base station 1002 may generate data to be transmitted by using the codeword generation information described above and the data received from the first base station 1001. The first base station 1001 may transmit a PDSCH scheduling DCI on the third NTN link 1053 (i.e. sub-link) in step S1412. The PDSCH scheduling DCI on the third NTN link 1053 may include information on a base station of the second NTN link 1052 and information on the HARQ process number.

The reason for including the information on the base station of the second NTN link 1052 in the PDSCH scheduling DCI on the third NTN link 1053 is to inform that the PDSCH scheduling DCI is related to the data transmitted through the second NTN link 1052.

In step S1412, the terminal 1010 may receive the PDSCH scheduling DCI through the third NTN link 1053.

In step S1414, the first base station 1001 may transmit a PDSCH through the third NTN link 1053 based on the DCI configured in step S1412. In this case, the first base station 1001 may also deliver an identifier for the second base station 1002 that has performed the initial transmission in addition to the HARQ process number. The reason for delivering the identifier for the second base station 1002 is because there may be other base stations using the third NTN link as a sub-link in addition to the second base station 1002 illustrated in FIG. 14. However, if it is known in advance that there is no additional base station using the third NTN link as a sub-link other than the second base station 1002, the first base station 1001 may transmit only the retransmitted data through the third NTN link 1053, and may not transmit the identifier for the second base station 1002.

In step S1414, the terminal 1010 may receive the PDSCH through the third NTN link based on the DCI received in step S1412. In addition, the terminal 1010 may demodulate and decode data in the PDSCH received through the third NTN link 1053. The terminal 1010 may detect errors by using only the decoded data or by combining it which the initially transmitted data.

In step S1416, the terminal 1010 may transmit a result of error detection in step S1414 to the first base station 1001 through the third NTN link 1053, as an HARQ feedback for the PDSCH.

A method of transmitting the HARQ feedback in FIG. 14 may be considered as in other exemplary embodiments described above. For example, the terminal 1010 may be configured based on various conditions to transmit the HARQ feedback through the second NTN link 1052 or the third NTN link 1053 according to what has been previously described in FIG. 11A or FIG. 11B.

In FIGS. 11A and 11B described above, an HARQ feedback corresponding to retransmission data has not been described. Therefore, various methods as an HARQ feedback method for the retransmitted data described in FIG. 14 will be described in connection with the case of FIGS. 11A and 11B described above.

First, when configuring the HARQ feedback described in FIG. 11A, all HARQ feedbacks may be configured to be transmitted through the second NTN link 1052 without distinguishing between initial transmission and retransmission. In this case, the HARQ feedback for the PDSCH transmitted through the third NTN link 1053 may be transmitted through the second NTN link 1052, unlike step S1416 of FIG. 14.

Second, the HARQ feedback configuration described in FIG. 11A may be applied only to initial transmission. In this case, the HARQ feedback for the PDSCH transmitted through the third NTN link 1053 may be transmitted through the third NTN link 1053, which is a sub-link through which the retransmission data is received, as in step S1416 illustrated in FIG. 14.

Third, when configuring the HARQ feedback described in FIG. 11B, all HARQ feedbacks for all data of initial transmission and retransmission may be configured to be transmitted through the third NTN link 1055. In this case, the HARQ feedback for the PDSCH transmitted through the third NTN link 1053 may be transmitted through the third NTN link 1053 as in step S1416 illustrated in FIG. 14.

Fourth, when configuring the HARQ feedback described in FIG. 11B, the HARQ feedback may be configured to be limited to initial transmission only. Therefore, the HARQ feedback for retransmission data may be determined according to a scheme separately configured by the first base station 1001 and/or the second base station 1002.

Hereinafter, operations assuming the case where the terminal 1010 transmits, through the third NTN link 1053, a feedback for retransmission data received through the third NTN link 1053 (i.e. sub-link) as illustrated in FIG. 14 will be described.

The first base station 1001 may receive the HARQ feedback corresponding to data retransmitted through the third NTN link 1053 from the terminal 1010 in step S1416. The first base station 1001 may perform step S1418 when the received HARQ feedback indicates an ACK indicating that there is no error in the data retransmitted through the third NTN link 1053. On the other hand, when the received HARQ feedback indicates a NACK indicating that there is an error in the data retransmitted through the third NTN link 1053, the first base station 1001 may repeatedly perform the operations from step S1412 to step S1416.

When the first base station 1001 repeatedly performs the operations from steps S1412 to S1416 based on the NACK indicating that there is an error in the data retransmitted through the third NTN link 1053, the first base station 1001 may repeat the operations from steps S1412 to S1416 based on a predetermined number of retransmissions. If a NACK is received as an HARQ feedback even as a result of all repetitions, the first base station 1001 may perform step S1418.

In step S1418, based on the HARQ feedback received from the terminal 1010, the first base station 1001 may deliver information on whether the data corresponding to the HARQ process number has been successfully decoded at the terminal 1010 to the second base station 1002. In this case, the first base station 1001 may deliver the information on whether the data corresponding to the HARQ process number has been successfully decoded at the terminal 1010 to the second base station 1002 through the Xn interface 1006.

### [Retransmission Timing of a Sub-Link for NTN]

In the present disclosure described below, a retransmission timing when a NACK for initially transmitted data is received after initial transmission of the data is performed through an NTN link for data transmission will be described. In particular, a transmission timing for the above-described case that retransmission is performed through a sub-link (for a propagation delay gain) in a situation where one terminal is in a state of multi-connectivity with multiple links will be described.

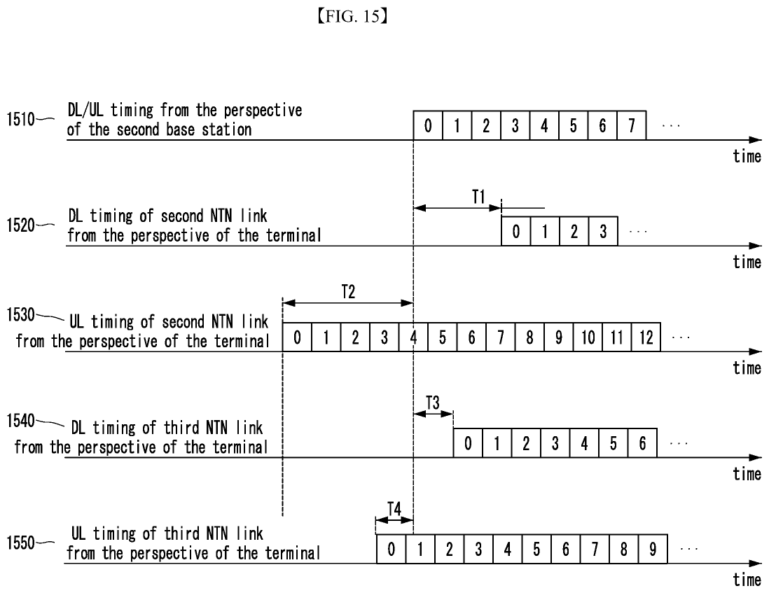

FIG. 15 is a timing diagram for respective links when one terminal retransmits data through a sub-link in a situation where one terminal is in a state of multi-connectivity with multiple links according to an exemplary embodiment of the present disclosure.

In the present disclosure, in a situation where one terminal is in a state of multi-connectivity with multiple links, a link with a short latency may be determined as a sub-link for a link with a long latency among the multiple links. In the present disclosure, since retransmission data is transmitted through the sub-link with a short latency, a situation in which a retransmission latency is relatively short is assumed. This situation may correspond to the situations in FIGS. 10A and 10B described above.

Hereinafter, in describing FIG. 15, description will be made assuming the configuration of FIG. 10A.

First, in FIG. 15, from the perspective of the first and second base stations, a DL/UL timing 1510 may be understood as corresponding to a case where the first base station 1001 transmits or receives data to or from the terminal 1010 using the first NTN link and/or the third NTN link and a case where the second base station 1002 performs initial transmission to the terminal 1010 using the second NTN link. Therefore, from the perspective of the first base station 1001 and the second base station 1002, the DL/UL timing 1510 may be a reference for timings described in FIG. 15. Hereinafter, for convenience of description, the reference timing will be described as the DL/UL timing 1510 from the perspective of the first base station for the case where transmission/reception is performed at the first base station 1001, and will be described as the DL/UL timing 1510 from the perspective of the second base station for the case where transmission/reception is performed at the second base station 1002.

As can be seen in FIG. 10A, from the perspective of the terminal, a delay of T1 may occur in the DL timing 1520 of the second NTN link because transmission to the terminal 1010 is performed via the second gateway 1032 and the second satellite 1042. Therefore, the delay of T1 may mean a delay from the second base station 1002 to the terminal 1010 through the second NTN link 1052. Specifically, the delay of T1 is may be a value equal to or greater than a total sum of a delay from the second base station 1002 to the second gateway 1032, a delay from the second gateway 1032 to the second satellite 1042, and a delay from the second satellite 1042 to the terminal 1010. The case where the delay of T1 is greater than the total sum of the delays mentioned above may correspond to a case where a processing time at the second gateway 1032 and the second satellite 1042 is not additionally considered.

In addition, since a UL timing 1530 of the second NTN link from the perspective of the terminal needs to match the DL/UL timing 1510 from the perspective of the second base station, transmission needs to be performed T2 earlier. Since a UL path of the second NTN link 1052 has the same path as a DL path from the perspective of the second base station 1002, T2 may be the same as T1.

The second base station 1002 may determine an HARQ feedback path for initial transmission data to the terminal 1010 as shown in FIG. 11A or FIG. 11B described above. After determining the HARQ feedback path, the second base station 1002 may inform the terminal 1010 of the HARQ feedback path. Thereafter, the second base station 1002 may transmit initial transmission data to the terminal 1010 through the second NTN link 1052.

In this case, for the initial transmission data, a transmission time at the second base station 1002 and a reception time at the terminal 1010 may be derived using the DL/UL timing 1510 from the perspective of the second base station and the DL timing 1520 of the second NTN link from the perspective of the terminal.

Since FIG. 15 is a diagram for describing transmission of retransmission data using the sub-link according to the present disclosure, a timing of the retransmission through the sub-link will be described.

When compared with the DL/UL timing 1510 from the perspective of the first base station, a delay of T3 may occur in a DL timing 1540 of the third NTN link from the perspective of the terminal. From the perspective of the terminal, the delay of T3 may occur because transmission is made to the terminal 1010 via the first base station 1001, the second gateway 1032, and the second satellite 1042.

Additionally, the delay of T1 and the delay of T3 may be determined based on the respective NTN paths as described in FIG. 10A. In other words, if the first satellite 1041 is a LEO satellite and the second satellite 1042 is a GEO satellite, the latency of the second NTN link 1052 via the second satellite 1042 is greater than the latency of the third NTN link 1053 via the first satellite 1041.

Therefore, as illustrated in FIG. 15, the delay T3 in the DL timing 1540 of the third NTN link from the perspective of the terminal is shorter than the delay T1 in the DL timing 1510 of the second NTN link from the perspective of the terminal.

Since an UL timing 1550 of the third NTN link from the perspective of the terminal needs to match the DL/UL timing 1510 from the perspective of the first base station, transmission needs to occur T4 earlier. Since the UL path of the third NTN link 1053 has the same path as the DL path from the perspective of the first base station 1001, T4 may be the same as T3.

As described above, when the first base station 1001 transmits retransmission data to the terminal 1010 through the third NTN link 1053 (i.e. sub-link), the second base station 1002 may not perform operations related to retransmission. Therefore, there are no special operations between the first base station 1001 and the second base station 1002. The DL timing 1520 of the second NTN link from the perspective of the terminal and the UL timing 1530 of the second NTN link from the perspective of the terminal may not need to be considered for the retransmission data.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1. A method of a first communication node, comprising:
requesting allocation of a resource on a second non-terrestrial network (NTN) link between a second communication node and a user equipment (UE) to receive a hybrid automatic repeat request (HARQ) feedback from the UE via the second communication node;
in response to a response of acceptance to the allocation of the resource on the second NTN link from the second communication node, transmitting, through a first NTN link via a first satellite, downlink control information (DCI) for transmitting data to the UE;
transmitting the data to the UE through the first NTN link based on the DCI; and
receiving an HARQ feedback signal corresponding to the transmitted data from the UE via the second communication node.

2. The method according to claim 1, wherein the second NTN link is a link with a shorter latency than the first NTN link.

3. The method according to claim 1, wherein the downlink control information includes an indicator indicating to transmit the HARQ feedback signal through the second NTN link and allocation information of at least one of a physical uplink control channel (PUCCH) or physical uplink shared channel (PUSCH) on the second NTN link to transmit the HARQ feedback signal.

4. The method according to claim 3, wherein the allocation information of the PUCCH on the second NTN link includes information on a transmission timing, time resource-related information, and frequency resource-related information for the PUCCH on the second NTN link.

5. The method according to claim 1, wherein the HARQ feedback signal corresponding to the transmitted data, which is received from the second communication node, is received through a backhaul using an Xn interface between the second communication node and the first communication node.

6. The method according to claim 1, wherein the second NTN link is a link established for communication between the second communication node and the UE via a second satellite.

7. The method according to claim 1, further comprising:
in response to that the HARQ feedback signal received from the UE indicates a data decoding failure, determining an NTN link to retransmit the transmitted data;
in response to that the determined NTN link is the second NTN link, transmitting, to the second communication node, a retransmission request including retransmission data and an HARQ process number; and
receiving, from the second communication node, information on whether or not the retransmission data is successfully received at the UE.

8. The method according to claim 7, wherein in the determining of the link to retransmit the transmitted data, the link is determined based on at least one of a Quality of Service (QoS) required by the transmitted data, characteristics of the transmitted data, or a congestion level of the second communication node.

9. A method of a first communication node, comprising:
receiving, from a second communication node, a request for allocation of a resource on a first non-terrestrial network (NTN) link to receive a hybrid automatic repeat request (HARQ) feedback for data transmitted through a second NTN link established between the second communication node and a user equipment (UE);
in response to the request for allocation, allocating a resource on the first NTN link for receiving a first HARQ feedback signal from the UE for data transmitted through the second NTN link;
in response to allocating the resource, transmitting an acceptance response signal including information on the resource allocated on the first NTN link to the second communication node;
in response to the information on the resource allocated on the first NTN link, receiving the first HARQ feedback signal from the UE for the data transmitted through the second NTN link; and
delivering the received first HARQ feedback signal to the second communication node.

10. The method according to claim 9, wherein the first NTN link is a link with a shorter latency than the second NTN link.

11. The method according to claim 9, wherein the resource allocated on the first NTN link is at least one of a physical uplink control channel (PUCCH) resource or physical uplink shared channel (PUSCH) resource.

12. The method according to claim 11, wherein in the allocating of the resource on the first NTN link for receiving the first HARQ feedback signal for data transmitted through the second NTN link, whether to allocate the resource on the first NTN link is determined based on at least one of whether a resource allocatable as a PUCCH resource exists, a congestion level of the first NTN link, or a load state of the first communication node.

13. The method according to claim 9, wherein the allocation information of the PUCCH on the first NTN link includes information on a transmission timing, time resource-related information, and frequency resource-related information for the PUCCH on the first NTN link.

14. The method according to claim 9, wherein the first HARQ feedback, which is received from the second communication node, is received through a backhaul using an Xn interface with the second communication node.

15. The method according to claim 9, further comprising:
receiving, from the second communication node, a retransmission request for the data transmitted through the second NTN link;
transmitting retransmission data to the UE through the first NTN link based on the retransmission request; and
receiving, from the UE, a second HARQ feedback signal corresponding to the retransmission data.

16. The method according to claim 15, wherein the retransmission request includes the retransmission data and an HARQ process number.

17. The method according to claim 15, further comprising: delivering the received second HARQ feedback signal for the retransmission data to the second communication node.

18. A method of a user equipment (UE), comprising:
receiving downlink control information (DCI) through a first non-terrestrial network (NTN) link via a first satellite;
receiving data through the first NTN link based on the DCI;
demodulating and decoding the data received through the first NTN link;
generating a first hybrid automatic repeat request (HARQ) feedback signal based on a result of the decoding; and
in response to the DCI indicating to transmit the first HARQ feedback signal through a second NTN link via a second satellite, transmitting the first HARQ feedback signal corresponding to the data received through the first NTN link to the second satellite of the second NTN link.

19. The method according to claim 18, wherein the DCI includes an indicator indicating to transmit the first HARQ feedback signal through the second NTN link, time resource-related information, and frequency resource-related information.

20. The method according to claim 18, wherein the second NTN link is a link established for communication via the second satellite.
